(19) United States
(12) Patent Application Publication
(10) Pub. No.: US 2024/0097999 A1
(43) Pub. Date: Mar. 21, 2024

(54) METHODS AND SYSTEMS FOR DISTRIBUTED MACHINE LEARNING BASED ANOMALY DETECTION IN AN ENVIRONMENT COMPOSED OF SMARTNICS

(71) Applicant: Pensando Systems Inc., Milpitas, CA (US)

(72) Inventors: Yan Sun, San Jose, CA (US); Shrey Ajmera, Milpitas, CA (US)

(21) Appl. No.: 17/949,998

(22) Filed: Sep. 21, 2022

(51) Int. Cl. H04L 43/062; G06N 20/20; H04L 41/16; H04L 43/0823

(52) U.S. Cl. CPC H04L 43/062; G06N 20/20; H04L 41/16; H04L 43/0823

(57) ABSTRACT

Edge nodes, such as SmartNICs, routers, and switches can process the network traffic of workloads running on servers. The edge node can produce measurement streams that include measurement values produced by measuring one or more network performance metric. The measurement streams can be sent to anomaly detectors that are running on the edge nodes. The anomaly detectors can detect anomalies in the measurement streams and can report the anomalies to a person or a process designated to or subscribed for receiving the anomaly reports. An anomaly in the measurement stream can indicate anomalous network traffic and an anomaly detector can use an unsupervised machine learning model to detect the anomalies. The machine learning model may have been trained by an unsupervised machine learning algorithm that adapts the machine learning model for detecting anomalies in the measurement stream.

### TECHNICAL FIELD

The embodiments relate to computer networks, local area networks, network appliances such as routers, switches, network interface cards (NICs), smart NICs, and distributed service cards (DSCs). The embodiments also relate to packet processing pipelines, application specific integrated circuits implementing packet processing pipelines, and to providing network services and processing the packets of network flows. Additionally, the embodiments relate to unsupervised machine learning, and in particular to using distributed and unsupervised machine learning for detecting anomalous processing of network packets.

### BACKGROUND

Network appliances process network traffic flows by receiving network packets and processing the network packets. The network packets are often processed by examining the packet's header data and applying rules such as routing rules, firewall rules, load balancing rules, etc. Packet processing can be performed by a packet processing pipeline such as a “P4” packet processing pipeline. The concept of a domain-specific language for programming protocol-independent packet processors, known simply as “P4,” developed as a way to provide some flexibility at the data plane of a network appliance. The P4 domain-specific language for programming the data plane of network appliances is currently defined in the “P416 Language Specification,” version 1.2.2, as published by the P4 Language Consortium on May 17, 2021, which is incorporated by reference herein. P4 (also referred to herein as the “P4 specification,” the “P4 language,” and the “P4 program”) is designed to be implementable on a large variety of targets including switches, routers, programmable NICs, software switches, field programmable gate arrays (FPGAs), and application specific integrated circuits (ASICs). As described in the P4 specification, the primary abstractions provided by the P4 language relate to header types, parsers, tables, actions, match-action units, control flow, extern objects, user-defined metadata, and intrinsic metadata.

Various events, such as updating the configuration of a packet processing pipeline, changing routing rules, hardware instability, etc. can lead to anomalies in the processing of network packets and can lead to network failures.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

One aspect of the subject matter described in this disclosure can be implemented in a system. The system can include a memory, a CPU core operatively coupled to the memory and an edge node that includes the memory and the CPU core, wherein the edge node processes network traffic and provides networking services to a plurality of workloads, the edge node produces a measurement stream that includes a plurality of measurement values for at least one network performance metric, the measurement stream is submitted to an anomaly detector that is running on the edge node, the anomaly detector detects an anomaly in the measurement stream, the anomaly detector reports the anomaly, the anomaly detector uses a machine learning model to detect the anomaly, the machine learning model is adapted for detecting anomalies in the measurement stream by an unsupervised machine learning algorithm, and the anomaly in the measurement stream indicates anomalous network traffic.

Another aspect of the subject matter described in this disclosure can be implemented in a method. The method can include processing network traffic at a plurality of edge nodes that are configured to provide networking services to a plurality of workloads. The method can also include storing, by a central training node, an initial measurement set that includes a plurality of measurement values for at least one network performance metric that is related to processing of network traffic. The method can further include using an unsupervised machine learning algorithm to adapt a central model to detect an anomaly in the initial measurement set, and deploying the central model to the edge nodes, wherein the edge nodes are running a plurality of anomaly detectors, the central model is installed in the anomaly detectors as a plurality of edge models, and the edge nodes use the anomaly detectors to detect anomalous network traffic processing.

Yet another aspect of the subject matter described in this disclosure can be implemented in a system. The system can include a network traffic processing means for providing networking services to a plurality of workloads, a measurement means for producing a measurement stream for at least one network performance metric, an anomaly detection means for detecting an anomaly in the measurement stream, and a reporting means for reporting the anomaly, wherein an unsupervised machine learning algorithm adapts a machine learning model for detecting anomalies in the measurement stream, the anomaly detection means uses the machine learning model to detect the anomaly, and the anomaly in the measurement stream indicates anomalous network traffic.

In some implementations of the methods and devices, the edge node includes a packet processing pipeline circuit that includes a plurality of match action units arranged as a match action pipeline, and the edge node uses at least one of the match action units to produce the measurement stream. In some implementations of the methods and devices, a central training node receives an initial measurement set that includes an initial plurality of measurement values for the at least one network performance metric, the central training node uses the unsupervised machine learning algorithm adapts a central model to detect the anomaly, the central model is installed in the edge node as an edge model, and the machine learning model used by the anomaly detector is the edge model.

In some implementations of the methods and devices, the edge node receives a trained central model from a central training node, the edge node installs the trained central model as an edge model in the anomaly detector, and the edge model is the machine learning model. In some implementations of the methods and devices, the edge node uses the unsupervised machine learning algorithm to further adapt the edge model for detecting anomalies in the measurement stream. In some implementations of the methods and devices, the trained central model meets a central goodness of fit criterion, the edge node has an edge goodness of fit criterion for the edge model, and the edge node adapts the edge model for detecting anomalies in the measurement stream until the edge model meets the edge goodness of fit criterion. In some implementations of the methods and devices, the edge node produces a first edge model training measurement stream, and the edge node uses the unsupervised machine learning algorithm and the first edge model training measurement stream to further adapt the edge model for detecting anomalies in the measurement stream. In some implementations of the methods and devices, the unsupervised machine learning algorithm is a K-means cluster learning algorithm. In some implementations of the methods and devices, a second unsupervised machine learning algorithm adapts a second machine learning model for detecting anomalies in the measurement stream, the anomaly detector uses the second machine learning model to detect a second anomaly, and the second machine learning model is a random cut forest learning algorithm.

In some implementations of the methods and devices, the unsupervised machine learning algorithm is a clustering algorithm. In some implementations of the methods and devices, the unsupervised machine learning algorithm is a K-means cluster learning algorithm. In some implementations of the methods and devices, the unsupervised machine learning algorithm is a random cut forest learning algorithm. In some implementations of the methods and devices, a central training node adapts a central model for detecting the anomaly, a plurality of edge nodes install the central model as a plurality of edge models, and at least two of the edge nodes use the edge models to detect the anomalous network traffic. In some implementations of the methods and devices, a network configuration update is applied to the edge node before the anomaly is detected, and the edge node automatically rolls back the network configuration update after the anomaly is detected. In some implementations of the methods and devices, the measurement stream includes values for a plurality of network performance metrics.

In some implementations of the methods and devices, at least one of the edge nodes produces the initial measurement set. In some implementations of the methods and devices, one of the edge nodes includes a pipeline circuit that includes a match action pipeline, the one of the edge nodes uses the pipeline circuit to produce a measurement stream, and the one of the edge nodes uses the measurement stream and one of the anomaly detectors to detect the anomalous network traffic processing.

In some implementations of the methods and devices, the system also includes a network configuration means for updating a network configuration from a first network configuration to a second network configuration, and a rollback triggering means for triggering a configuration rollback means to roll back the network configuration from the second network configuration to the first network configuration.

These and other aspects will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

FIG. 1 is a high-level conceptual diagram of a system using unsupervised machine learning to detect anomalies in measurement streams according to some aspects.

FIG. 2 is a functional block diagram of a network appliance having a control plane and a data plane and in which aspects may be implemented.

FIG. 3 is a functional block diagram illustrating an example of a match-action unit in a match-action pipeline according to some aspects.

FIG. 4 is a functional block diagram of a network appliance having an application specific integrated circuit (ASIC), according to some aspects.

FIG. 5 is a high-level diagram illustrating an example of generating a packet header vector from a packet according to some aspects.

FIG. 6 illustrates a block diagram of a match processing unit (MPU) that may be used within the exemplary system of FIG. 4 to implement some aspects.

FIG. 7 illustrates a block diagram of a packet processing pipeline circuit that may be included in the exemplary system of FIG. 4.

FIG. 8 illustrates packet headers and payloads of packets for network traffic flows including layer 7 fields according to some aspects.

FIG. 9 is a high-level diagram illustrating edge nodes providing networking services to workloads according to some aspects.

FIG. 10 is a high-level diagram illustrating a measurement stream and a measurement set according to some aspects.

FIG. 11 is a high-level diagram illustrating an edge node producing a measurement stream that includes measurement values for a network performance metric according to some aspects.

FIG. 12A and FIG. 12B are high-level diagrams illustrating the production and storage of measurement values for network performance metrics according to some aspects.

FIG. 13 is a high-level diagram illustrating network performance metrics that can be measured to produce measurement values according to some aspects.

FIG. 14 is a high-level diagram illustrating network performance metric measurement policies according to some aspects.

FIG. 15 is a high-level diagram illustrating a central training node and an edge node using K-means machine learning techniques and random cut forest machine learning techniques according to some aspects.

FIG. 16 is a high-level flow diagram illustrating a central model deployment process that a central training node can implement for deploying a trained central model to edge nodes according to some aspects.

FIG. 17 is a high-level flow diagram illustrating an anomaly detection process that can be implemented by an edge node that has an anomaly detector using an edge model to detect anomalies according to some aspects.

FIG. 18 is a high-level flow diagram illustrating an anomaly detection process that can be implemented by an edge node that has an anomaly detector using an edge model to detect anomalies and using a measurement stream to update the edge model according to some aspects.

FIG. 19 is a high-level flow diagram illustrating an automatic rollback process that rolls back a configuration update based on the number of detected anomalies according to some aspects.

FIG. 20 is a high-level flow diagram illustrating a method for using unsupervised learning to detect network traffic processing anomalies at edge nodes according to some aspects.

FIG. 21 is a high-level flow diagram illustrating a process for a K-means cluster learning algorithm to adapt a machine learning model for detecting an anomaly according to some aspects.

FIG. 22 is a high-level flow diagram illustrating a process that uses a machine learning model produced via a K-means cluster learning algorithm to detect an anomaly according to some aspects.

FIG. 23 is a high-level flow diagram illustrating a process for a random cut forest (RCF) learning algorithm to adapt a machine learning model for detecting an anomaly according to some aspects.

FIG. 24 is a high-level flow diagram illustrating a process that uses a machine learning model produced via a RCF learning algorithm to detect an anomaly according to some aspects.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The claimed embodiments may be embodied in other specific forms without departing from its spirit or essential characteristics. The described embodiments are to be considered in all respects only as illustrative and not restrictive. The scope of the claims is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

Telemetry data can be generated by network appliances such as SmartNICs, routers, and switches. In fact, telemetry data can be generated in such copious amounts that it can be difficult to transmit, store, and interpret. Transmitting the telemetry data to a central location can consume large amounts of bandwidth. Furthermore, the central location that receives the telemetry data must have an enormous amount of storage and considerable processing power in order to analyze the data. The data can be analyzed in a number of ways. Network administrators can attempt to filter out data that is within a normal range in order to concentrate on abnormal data, but even that is difficult because modern networks constantly encounter errors and abnormal events (lost packets, session drops, retransmits, bandwidth fluctuations, increased round trip time, etc.) and network problems can be difficult to differentiate from the normally problematic processing that normally occurs.

Anomaly detection has been an active field of research for generations. More recently, machine learning techniques have been used to detect anomalies. Unsupervised machine learning techniques are particularly helpful because they can learn what is normal and thereby detect what is abnormal. In general, it is assumed that a data set can include normal or non-anomalous data as well as anomalous data. It is further assumed that most of the data in a data set is normal data, that normal data is similar to other normal data and that data that is not similar to most of the other data in the data set is anomalous data.

One such machine learning technique is called “K-means” or “K-means clustering”. Those practiced in machine learning are familiar with clustering algorithms such as K-means algorithms. An early version of K-means was developed in the 1950s and it has developed as a class of clustering algorithms ever since. Students are often taught K-means in machine learning curriculums. The use of K-means for anomaly detection is more recent and is often used for preprocessing data sets in order to remove outliers (anomalous data) before the data sets are used for training supervised machine learning models such as convolutional neural nets. K-means algorithms attempt to find K clusters within a data set. Typically, K is a human supplied input parameter. Data that is not within any of the K-clusters is deemed anomalous. A K-means model can be developed from an initial data set (the training set) and then deployed as an anomaly detector.

Another class of algorithms, random cut forest (RCF) algorithms, has been gaining considerable attention for detecting anomalies in data sets and in streaming data. Various RCF implementations are widely available (e.g., Amazon SageMaker, installable python modules, github projects, etc.). RCF variations, all herein considered to be within the class of RCF algorithms, include robust random cut forest (RRCF) algorithms, isolation forest algorithms, weighted random cut forest algorithms, etc. The key operational distinction between algorithms such as K-means and RCF is that RCF can be applied to a data stream and can continue to “learn” while receiving the data stream. As such, a RCF model that is deployed as an anomaly detector may adapt over time to the data in the data stream. Those practiced in machine learning are familiar with many other unsupervised machine learning algorithms that are used to produce anomaly detectors.

As discussed above, the telemetry data collected by network appliances can be gathered at a central location and analyzed by unsupervised machine learning algorithms to detect anomalies and to produce anomaly detectors. The anomaly detectors are trained machine learning models.

Recently developed network appliances, such as SmartNICs and certain switches and routers have data planes that rapidly process network traffic and have control planes that can control/configure the data plane and that can perform other tasks. Such network appliances may be capable of producing telemetry data within the data plane. Furthermore, these network appliances can run trained anomaly detectors (e.g., K-means models) and can run anomaly detectors that can learn local network traffic characteristics (RCF models). The advantage is that the network appliances themselves can identify anomalies within the network traffic and within the network appliance's own processing of network traffic. The anomalies can thereby be detected rapidly at the point of occurrence instead of being eventually detected at a central location. Furthermore, the network appliances may be able to rapidly and automatically take some remedial action to mitigate the anomalies.

In the field of data networking, the functionality of network appliances such as switches, routers, and NICs are often described in terms of functionality that is associated with a “control plane” and functionality that is associated with a “data plane.” In general, the control plane refers to components and/or operations that are involved in managing forwarding information and the data plane refers to components and/or operations that are involved in forwarding packets from an input interface to an output interface according to the forwarding information provided by the control plane. The data plane may also refer to components and/or operations that implement packet processing operations related to encryption, decryption, compression, decompression, firewalling, and telemetry.

Aspects described herein process packets using match-action pipelines. A match-action pipeline is a part of the data plane that can process network traffic flows extremely quickly if the match-action pipeline is configured to process those traffic flows. Upon receiving a packet of a network traffic flow, the match-action pipeline can generate an index from data in the packet header. Finding a flow table entry for the network traffic flow at the index location in the flow table is the “match” portion of “match-action”. If there is a “match”, the “action” is performed to thereby process the packet. If there is no flow table entry for the network traffic flow, it is a new network traffic flow that the match-action pipeline is not yet configured to process. If there is no match, then the match-action pipeline can perform a default action.

The high-volume and rapid decision-making that occurs at the data plane is often implemented in fixed function application specific integrated circuits (ASICs). Although fixed function ASICs enable high-volume and rapid packet processing, fixed function ASICs typically do not provide enough flexibility to adapt to changing needs. Data plane processing can also be implemented in field programmable gate arrays (FPGAs) to provide a high level of flexibility in data plane processing.

Machine learning implementations can often be divided into two distinct phases: training; and inferencing. A model is developed during training and is used during inferencing. A training algorithm produces a trained model. For anomaly detection applications, the training algorithm produces a trained model by adapting a machine learning model for detecting anomalies. An inferencing algorithm uses the trained model to determine if a measurement is an anomaly. For example, a K-means training algorithm identifies K clusters in a data set and produces a trained K-means model. The trained K-means model can specify the K clusters by, for example, providing K cluster boundaries. A cluster boundary can be specified by its center and a distance from the center, the boundary edges (e.g., bounding box, hyper-ellipse, etc.), or in some other way. A K-means inferencing algorithm can receive a measurement and determine if the measurement is inside one of the clusters specified by a K-means model. Measurements outside the clusters are identified as anomalies. In another example, a RCF training algorithm can produce a trained RCF model by using the data set to produce a number of random cut trees (a forest includes many trees). The trained RCF model specifies the random cut trees in the random cut forest. The RCF inferencing algorithm uses the RCF trees in the model to determine if a measurement is an anomaly. In many implementations, the RCF inferencing algorithm may also use the measurement to modify at least some of the trees in the RCF such that the RCF model is adapted over time to the measurements that are received. Those practiced in machine learning are familiar with K-means inferencing algorithms, K-means training algorithms, RCF inferencing algorithms, and RCF training algorithms.

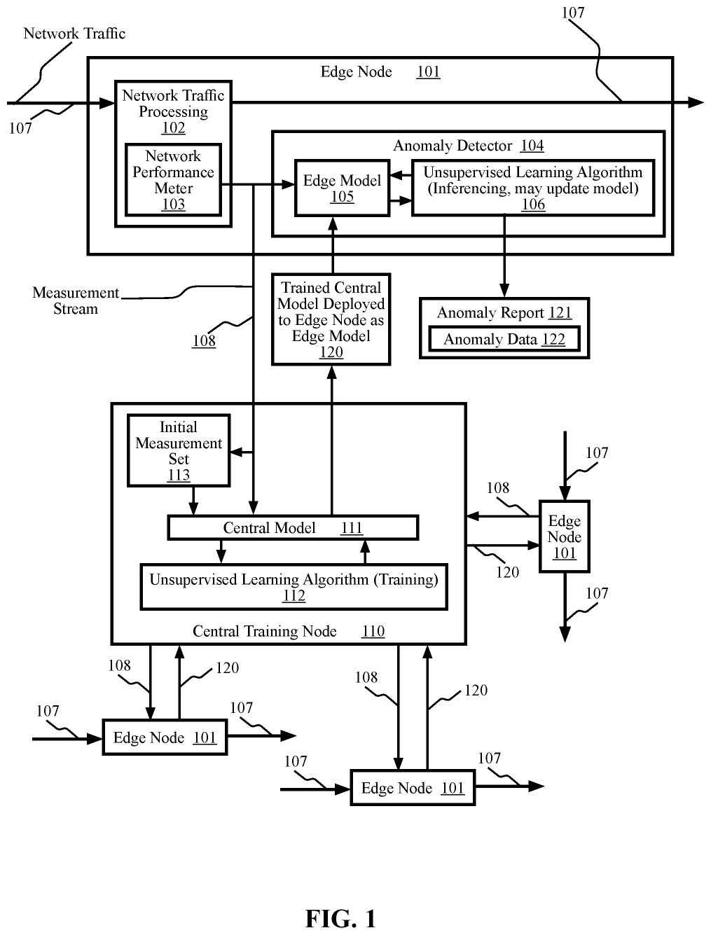

FIG. 1 is a high-level conceptual diagram of a system using unsupervised machine learning to detect anomalies in measurement streams 108 according to some aspects. An edge node 101 can process network traffic 107. The edge nodes 101 are network appliances that process network traffic. The network appliances are called edge nodes in order to distinguish them from the central training node 110 that, in many implementations, is not a network appliance. The edge node can include elements that perform network processing (network processing element 102) and anomaly detection (anomaly detector 104). The network processing element 102 can include a network performance meter 103. The network performance meter can produce a measurement stream 108. The measurement stream 108 can include a series over time of measurements of the network traffic (e.g., a bandwidth measurement every 5 seconds) and of the processing performed with respect to the network traffic (e.g., a connections per second measurement every second). The measurement stream can be sent to the anomaly detector 104 and may also be sent to the central training node 110. The central training node 110 may receive measurement streams from numerous edge nodes and may produce an initial measurement set 113 from those measurement streams. As discussed above, such measurement streams may include massive amounts of data. As such, the measurement streams sent to the central training node may be time limited (e.g., only sent from a start time to an end time), subsampled (e.g., every Nth measurement), or otherwise reduced in size from the measurement streams produced by the network performance meters 103 of the edge nodes 101.

The central training node 110 can include an unsupervised learning algorithm 112 that uses the initial measurement set 113 to train a central model 111. Those practiced in machine learning know that training a model can consume large amounts of time and resources, particularly when the initial measurement set is large. For example, it is common for machine learning models to take hours to be trained using hundreds of specialized processing nodes (e.g., tensor processing units). Once the central model 111 is trained it can be deployed to the edge nodes 101. When the trained central model 120 is deployed to an edge node 101 it becomes an edge model 105. The edge nodes 101 can store the edge models in their volatile or non-volatile memory.

The anomaly detector 104 can use the edge model 105 and an unsupervised learning algorithm 106. The edge model 105 can be a trained machine learning model such as a K-means model or a RCF model. The unsupervised learning algorithm 106 at the edge node 101 can perform inferencing whereby the edge model 105 is used to determine if a measurement is an anomaly. As discussed above, if the edge model 105 is a RCF model then the unsupervised learning algorithm 106 can be an RCF inferencing algorithm that also updates the RCF model. The anomaly detector 104 detects an anomaly when the unsupervised learning algorithm 106 determines that a measurement is an anomaly.

Upon detecting the anomaly, the anomaly detector 104 can produce an anomaly report 121 that includes anomaly data 122. The anomaly data can include the measurement (e.g., connections per second equals zero), a timestamp (e.g., time the measurement was taken, time anomaly was detected, etc.), and other information.

The anomaly detector 104 can receive every measurement produced by the network performance meter 103. As such, all the edge nodes in combination can inspect a vast amount of data for anomalies. The entire measurement streams from all the edge nodes may consume an impractically large amount of network resources if sent to the central training node 110. As such, the measurement streams 108 sent to the central training node may be subsampled, only sent during certain time windows, etc. Within the edge nodes, all of the measurements may be processed by the anomaly detector. As such, it is advantageous to run the anomaly detectors in the edge nodes.

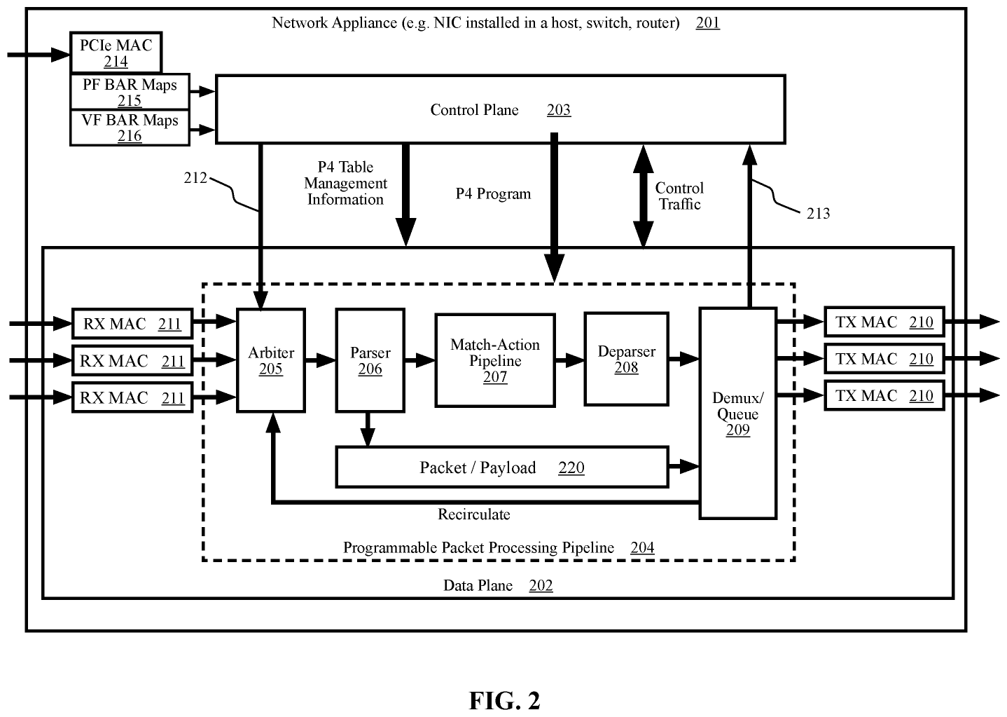

FIG. 2 is a functional block diagram of a network appliance having a control plane and a data plane and in which aspects may be implemented. A network appliance 201 can have a control plane 203 and a data plane 202. The control plane provides forwarding information (e.g., in the form of table management information or configuration data) to the data plane and the data plane receives packets on input interfaces, processes the received packets, and then forwards packets to desired output interfaces. Additionally, control traffic (e.g., in the form of packets) may be communicated from the data plane to the control plane and/or from the control plane to the data plane. The data plane and control plane are sometimes referred to as the “fast” plane and the “slow” plane, respectively. In general, the control plane is responsible for less frequent and less time-sensitive operations such as updating Forwarding Information Bases (FIB s) and Label Forwarding Information Bases (LFIBs), while the data plane is responsible for a high volume of time-sensitive forwarding decisions that need to be made at a rapid pace. The control plane may implement operations related to packet routing that include InfiniBand channel adapter management functions, Open Shortest Path First (OSPF), Enhanced Interior Gateway Routing Protocol (EIGRP), Border Gateway Protocol (BGP), Intermediate System to Intermediate System (IS-IS), Label Distribution Protocol (LDP), routing tables and/or operations related to packet switching that include Address Resolution Protocol (ARP) and Spanning Tree Protocol (STP). The data plane (which may also be referred to as the “forwarding” plane) may implement operations related to parsing packet headers, Quality of Service (QoS), filtering, encapsulation, queuing, and policing. Although some functions of the control plane and data plane are described, other functions may be implemented in the control plane and/or the data plane.

Some techniques exist for providing flexibility at the data plane of network appliances that are used in data networks. For example, the concept of a domain-specific language for programming protocol-independent packet processors, known simply as “P4,” has developed as a way to provide some flexibility at the data plane of a network appliance. The document “P416 Language Specification,” version 1.2.2, published by the P4 Language Consortium on May 17, 2021, which is incorporated by reference herein, describes the P4 domain-specific language that can be used for programming the data plane of network appliances. P4 (also referred to herein as the “P4 specification,” the “P4 language,” and the “P4 program”) is designed to be implementable on a large variety of targets including switches, routers, programmable NICs, software switches, FPGAs, and ASICs. As described in the P4 specification, the primary abstractions provided by the P4 language relate to header types, parsers, tables, actions, match-action units, control flow, extern objects, user-defined metadata, and intrinsic metadata.

The data plane 202 includes multiple receive (RX) media access controllers (MACs) 211 and multiple transmit (TX) MACs 210. The RX MACs 211 implement media access control on incoming packets via, for example, a MAC protocol such as Ethernet. The MAC protocol can be Ethernet and the RX MACs can be configured to implement operations related to, for example, receiving frames, half-duplex retransmission and back-off functions, Frame Check Sequence (FCS), interframe gap enforcement, discarding malformed frames, and removing the preamble, Start Frame Delimiter (SFD), and padding from a packet. Likewise, the TX MACs 210 implement media access control on outgoing packets via, for example, Ethernet. The TX MACs can be configured to implement operations related to, for example, transmitting frames, half-duplex retransmission and back-off functions, appending an FCS, interframe gap enforcement, and prepending a preamble, an SFD, and padding.

As illustrated in FIG. 2, a P4 program is provided to the data plane 202 via the control plane 203. Communications between the control plane and the data plane can use a dedicated channel or bus, can use shared memory, etc. The P4 program includes software code that configures the functionality of the data plane 202 to implement particular processing and/or forwarding logic and to implement processing and/or forwarding tables that are populated and managed via P4 table management information that is provided to the data plane from the control plane. Control traffic (e.g., in the form of packets) may be communicated from the data plane to the control plane and/or from the control plane to the data plane. In the context of P4, the control plane corresponds to a class of algorithms and the corresponding input and output data that are concerned with the provisioning and configuration of the data plane corresponds to a class of algorithms that describe transformations on packets by packet processing systems.

The data plane 202 includes a programmable packet processing pipeline 204 that is programmable using a domain-specific language such as P4 and that can be used to implement the programmable packet processing pipeline 204. As described in the P4 specification, a programmable packet processing pipeline can include an arbiter 205, a parser 206, a match-action pipeline 207, a deparser 208, and a demux/queue 209. The data plane elements described may be implemented as a P4 programmable switch architecture, as a P4 programmable NIC, as a P4 programmable router, or some other architecture. The arbiter 205 can act as an ingress unit receiving packets from RX MACs 211 and can also receive packets from the control plane via a control plane packet input 212. The arbiter 205 can also receive packets that are recirculated to it by the demux/queue 209. The demux/queue 209 can act as an egress unit and can also be configured to send packets to a drop port (the packets thereby disappear), to the arbiter via recirculation, and to the control plane 203 via an output CPU port 213. The control plane is often referred to as a CPU (central processing unit) although, in practice, control planes often include multiple CPU cores and other elements. The arbiter 205 and the demux/queue 209 can be configured through the domain-specific language (e.g., P4).

The parser 206 is a programmable element that can be configured through the domain-specific language (e.g., P4) to extract information from a packet (e.g., information from the header of the packet). As described in the P4 specification, parsers describe the permitted sequences of headers within received packets, how to identify those header sequences, and the headers and fields to extract from packets. The information extracted from a packet by the parser can be referred to as a packet header vector (PHV). The parser can identify certain fields of the header and can extract the data corresponding to the identified fields to generate the PHV. The PHV may include other data (often referred to as “metadata”) that is related to the packet but not extracted directly from the header, including for example, the port or interface on which the packet arrived at the network appliance. Thus, the PHV may include other packet related data (metadata) such as input/output port number, input/output interface, or other data in addition to information extracted directly from the packet header. The PHV produced by the parser may have any size or length. For example, the PHV may be at least 4 bits, 8 bits, 16 bits, 32 bits, 64 bits, 128 bits, 256 bits, or 512 bits. In some cases, a PHV having even more bits (e.g., 6 Kb) may include all relevant header fields and metadata corresponding to a received packet. The size or length of a PHV corresponding to a packet may vary as the packet passes through the match-action pipeline.

The deparser 208 is a programmable element that is configured through the domain-specific language (e.g., P4) to generate packet headers from PHVs at the output of match-action pipeline 207 and to construct outgoing packets by reassembling the header(s) such as Ethernet headers, internet protocol (IP) headers, InfiniBand protocol data units (PDUs), etc. as determined by the match-action pipeline. In some cases, a packet/payload may travel in a separate queue or buffer 220, such as a first-in-first-out (FIFO) queue, until the packet payload is reassembled with its corresponding PHV at the deparser to form a packet. The deparser may rewrite the original packet according to the PHV fields that have been modified (e.g., added, removed, or updated). In some cases, a packet processed by the parser may be placed in a packet buffer/traffic manager for scheduling and possible replication. In some cases, once a packet is scheduled and leaves the packet buffer/traffic manager, the packet may be parsed again to generate an egress PHV. The egress PHV may be passed through a match-action pipeline after which a final deparser operation may be executed (e.g., at deparser 208) before the demux/queue 209 sends the packet to the TX MAC 210 or recirculates it back to the arbiter 205 for additional processing.

A network appliance 201 can have a peripheral component interconnect extended (PCIe) interface such as PCIe media access control (MAC) 214. A PCIe MAC can have a base address register (BAR) at a base address in a host system's memory space. Processes, typically device drivers within the host system's operating system, can communicate with a NIC via a set of registers beginning with the BAR. Some PCIe devices are single root input output virtualization (SR-MY) capable. Such PCIe devices can have a physical function (PF) and a virtual function (VF). A PCIe SR-IOV capable device may have multiple VFs. A PF BAR map 215 can be used by the host machine to communicate with the PCIe card. A VF BAR map 216 can be used by a virtual machine (VM) running on the host to communicate with the PCIe card. Typically, the VM can access the NIC using a device driver within the VM and at a memory address within the VMs memory space. Many SR-IOV capable PCIe cards can map that location in the VM's memory space to a VF BAR. As such a VM may be configured as if it has its own NIC while in reality it is associated with a VF provided by a SR-IOV capable NIC. As discussed below, some PCIe devices can have multiple PFs. For example, a NIC can provide network connectivity via one PF and can provide an InfiniBand channel adapter via another PF. As such, the NIC can provide “NIC’ VFs and “InfiniBand” VFs to VMs running on the host. The InfiniBand PF and VFs can be used for data transfers, such as remote direct memory access (RDMA) transfers to other VMs running on the same or other host computers. Similarly, a NIC can provide non-volatile memory express (NVMe) and small computer system interface (SCSI) PFs and VFs to VMs running on the host.

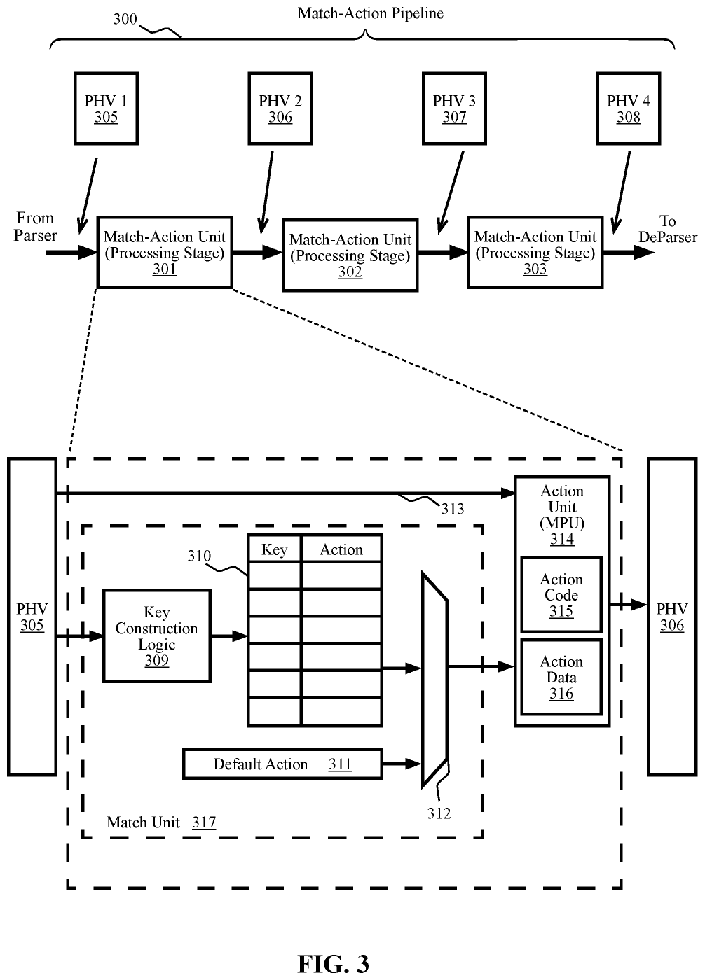

FIG. 3 is a functional block diagram illustrating an example of a match-action unit 301 in a match-action pipeline 300 according to some aspects. FIG. 3 introduces certain concepts related to match-action units and match-action pipelines and is not intended to be limiting. The match-action units are processing stages, often simply called stages, of the packet processing pipeline. The match-action units 301, 302, 303 of the match-action pipeline 300 are programmed to perform “match-action” operations in which a match unit performs a lookup using at least a portion of the PHV and an action unit performs an action based on an output from the match unit. A PHV generated at the parser may be passed through each of the match-action units in the match-action pipeline in series and each match-action unit can implement a match-action operation or policy. The PHV and/or table entries may be updated in each stage of match-action processing according to the actions specified by the P4 programming. In some instances, a packet may be recirculated through the match-action pipeline, or a portion thereof, for additional processing. Match-action unit 1 301 receives PHV 1 305 as an input and outputs PHV 2 306. Match-action unit 2 302 receives PHV 2 306 as an input and outputs PHV 3 307. Match-action unit 3 303 receives PHV 3 307 as an input and outputs PHV 4 308.

An expanded view of elements of a match-action unit 301 of match-action pipeline 300 is shown. The match-action unit includes a match unit 317 (also referred to as a “table engine”) that operates on an input PHV 305 and an action unit 314 that produces an output PHV 306, which may be a modified version of the input PHV 305. The match unit 317 can include key construction logic 309, a lookup table 310, and selector logic 312. The key construction logic 309 is configured to generate a key from at least one field in the PHV (e.g., 5-tuple, InfiniBand queue pair identifiers, etc.). The lookup table 310 is populated with key-action pairs, where a key-action pair can include a key (e.g., a lookup key) and corresponding action code 315 and/or action data 316. A P4 lookup table may be viewed as a generalization of traditional switch tables, and can be programmed to implement, for example, routing tables, flow lookup tables, access control lists (ACLs), and other user-defined table types, including complex multi-variable tables. The key generation and lookup functions constitute the “match” portion of the operation and produce an action that is provided to the action unit via the selector logic. The action unit executes an action over the input data (which may include data 313 from the PHV) and provides an output that forms at least a portion of the output PHV. For example, the action unit executes action code 315 on action data 316 and data 313 to produce an output that is included in the output PHV 306. If no match is found in the lookup table, then a default action 311 may be implemented. A flow miss is an example of a default action that may be executed when no match is found. The operations of the match-action unit can be programmable by the control plane via P4 and the contents of the lookup table can be managed by the control plane.

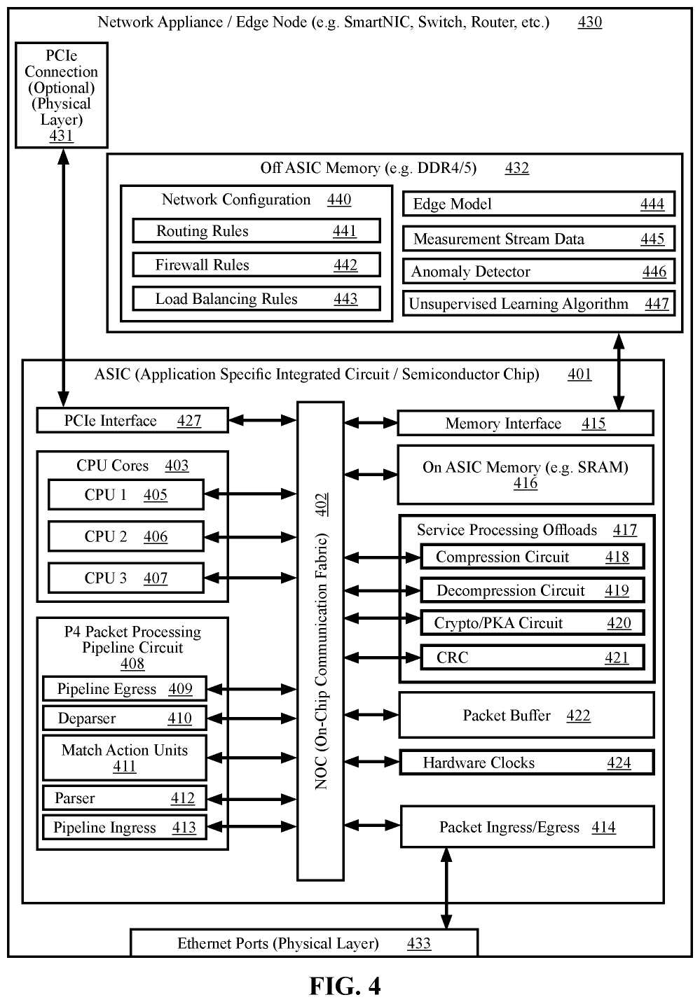

FIG. 4 is a functional block diagram of a network appliance 430 having an application specific integrated circuit (ASIC) 401, according to some aspects. If the network appliance is a network interface card (NIC) then the NIC can be installed in a host computer and can act as a network appliance for the host computer and for virtual machines running on the host computer. Such a NIC can have a PCIe connection 431 for communicating with the host computer. The network appliance 430 can have an ASIC 401, off ASIC memory 432, and ethernet ports 433. The off ASIC memory 432 can be one of the widely available memory modules or chips such as double data rate 4 (DDR4) synchronous dynamic random-access memory (SDRAM) such that the ASIC has access to many gigabytes of memory on the network appliance 430. The ethernet ports 433 provide physical connectivity to a computer network such as the internet.

The ASIC 401 is a semiconductor chip having many core circuits interconnected by an on-chip communications fabric, sometimes called a network on a chip (NOC) 402. NOCs are often implementations of standardized communications fabrics such as the widely used advanced extensible interface (AXI) bus. The ASIC's core circuits can include a PCIe interface 427, CPU cores 403, P4 packet processing pipeline 408 elements, memory interface 415, on ASIC memory such as static random access memory (SRAM) 416, service processing offloads 417, a packet buffer 422, extended packet processing pipeline 423, and packet ingress/egress circuits 414. The PCIe interface 427 can be used to communicate with a host computer via the PCIe connection 431. The CPU cores 403 can include numerous CPU cores such as CPU 1 405, CPU 2 406, and CPU 3 407. The P4 packet processing pipeline circuit 408 can include a pipeline ingress circuit 413, a parser circuit 412, match-action units 411, a deparser circuit 410, and a pipeline egress circuit 409. The service processing offloads 417 are circuits implementing functions that the ASIC uses so often that the designer has chosen to provide hardware for offloading those functions from the CPUs. The service processing offloads can include a compression circuit 418, decompression circuit 419, a crypto/PKA circuit 420, and a cyclic redundancy check (CRC) calculation circuit 421. The specific core circuits implemented within the non-limiting example of ASIC 401 can be selected such that the ASIC implements many, perhaps all, of the functionality of an InfiniBand channel adapter, of an NVMe card, and of a network appliance that processes network traffic flows carried by internet protocol (IP) packets.

A network device can include precision clocks that output a precise time, clocks that are synchronized to remote authoritative clocks via precision time protocol (PTP), and hardware clocks 424. A hardware clock may provide a time value (e.g., year/day/hour/minute/second/ . . . ) or may simply be a counter that is incremented by one at regular intervals (e.g., once per clock cycle for a device having a 10 nsec. clock period). Time values obtained from the clocks can be used as timestamps for events such as enqueuing/dequeuing a packet, producing measurements of network traffic and network traffic processing, etc.

The P4 packet processing pipeline circuit 408 is a specialized set of elements for processing network packets such as IP (internet protocol) packets and InfiniBand PDUs (protocol data units). The P4 pipeline can be configured using a domain-specific language such as the P4 domain specific language. As described in the P4 specification, the primary abstractions provided by the P4 language relate to header types, parsers, tables, actions, match-action units, control flow, extern objects, user-defined metadata, and intrinsic metadata.

The network appliance 430 can include a memory 432 for running Linux or some other operating system and for storing data used by the processes implementing network services, upgrading the control plane, and upgrading the data plane. The network appliance can use the memory 432 to store the network configuration data 440, edge models 444, measurement stream data 445, anomaly detectors 446, and unsupervised learning algorithms 447. The network configuration data 440 can include routing rules 441, firewall rules 442, load balancing rules 443, and other types of networking rules.

The CPU cores 403 can be general purpose processor cores, such as ARM processor cores, microprocessor without interlocked pipelined stages (MIPS) processor cores, and/or x86 processor cores, as is known in the field. Each CPU core can include a memory interface, an arithmetic logic unit (ALU), a register bank, an instruction fetch unit, and an instruction decoder, which are configured to execute instructions independently of the other CPU cores. The CPU cores may be Reduced Instruction Set Computers (RISC) CPU cores that are programmable using a general-purpose programming language such as C.

The CPU cores 403 can also include a bus interface, internal memory, and a memory management unit (MMU) and/or memory protection unit. For example, the CPU cores may include internal cache, e.g., L1 cache and/or L2 cache, and/or may have access to nearby L2 and/or L3 cache. Each CPU core may include core-specific L1 cache, including instruction-cache and data-cache and L2 cache that is specific to each CPU core or shared amongst a small number of CPU cores. L3 cache may also be available to the CPU cores.

There may be multiple CPU cores 403 available for control plane functions and for implementing aspects of a slow data path that includes software implemented packet processing functions. The CPU cores may be used to implement discrete packet processing operations such as L7 applications (e.g., HTTP load balancing, L7 firewalling, and/or L7 telemetry), certain InfiniBand channel adapter functions, flow table insertion or table management events, connection setup/management, multicast group join, deep packet inspection (DPI) (e.g., URL inspection), storage volume management (e.g., NVMe volume setup and/or management), encryption, decryption, compression, and decompression, which may not be readily implementable through a domain-specific language such as P4, in a manner that provides fast path performance as is expected of data plane processing.

The packet buffer 422 can act as a central on-chip packet switch that delivers packets from the network interfaces 433 to packet processing elements of the data plane and vice-versa. The packet processing elements can include a slow data path implemented in software and a fast data path implemented by packet processing circuit 408.

The packet processing pipeline circuit 408 can be a specialized circuit or part of a specialized circuit using one or more ASICs or FPGAs to implement programmable packet processing pipelines such as the programmable packet processing pipeline 204 of FIG. 2. Some embodiments include ASICs or FPGAs implementing a P4 pipeline as a fast data path within the network appliance. The fast data path is called the fast data path because it processes packets faster than a slow data path that can also be implemented within the network appliance. An example of a slow data path is a software implemented data path wherein the CPU cores 403 and memory 432 are configured via software to implement a slow data path. A network appliance having two data paths has a fast data path and a slow data path when one of the data paths processes packets faster than the other data path.

All memory transactions in the network appliance 430, including host memory transactions, on board memory transactions, and register reads/writes may be performed via a coherent interconnect 402. In one non-limiting example, the coherent interconnect can be provided by a network on a chip (NOC) “IP core”. Semiconductor chip designers may license and use prequalified IP cores within their designs. Prequalified IP cores may be available from third parties for inclusion in chips produced using certain semiconductor fabrication processes. A number of vendors provide NOC IP cores. The NOC may provide cache coherent interconnect between the NOC masters, including the packet processing pipeline circuit 408, CPU cores 403, memory interface 415, and PCIe interface 427. The interconnect may distribute memory transactions across a plurality of memory interfaces using a programmable hash algorithm. All traffic targeting the memory may be stored in a NOC cache (e.g., 1 MB cache). The NOC cache may be kept coherent with the CPU core caches.

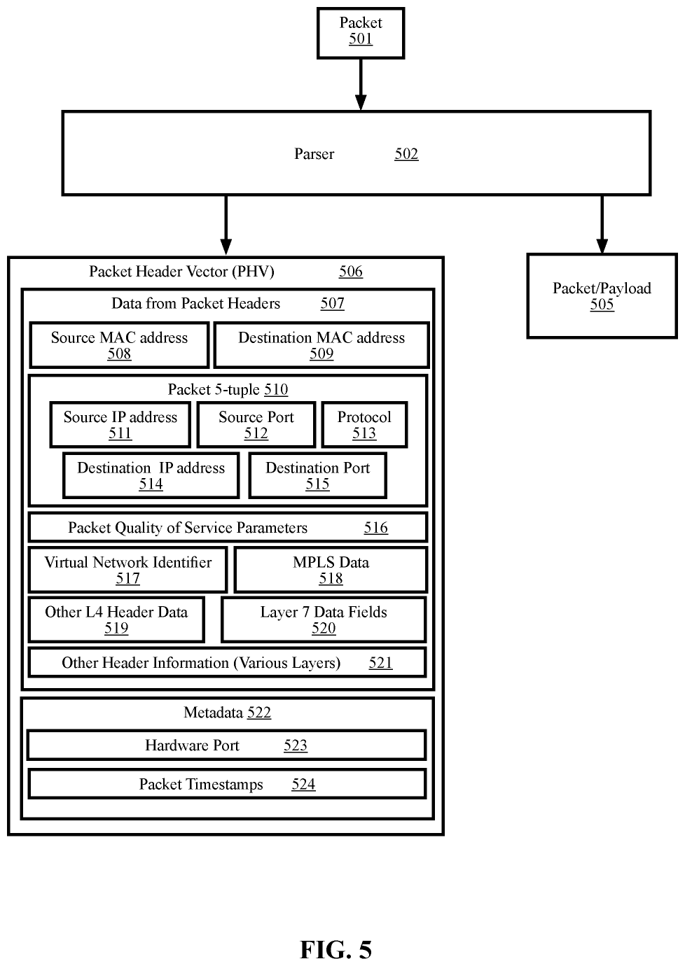

FIG. 5 is a high-level diagram illustrating an example of generating a packet header vector 506 from a packet 501 according to some aspects. The parser 502 can receive a packet 501 that has layer 2, layer 3, layer 4, and layer 7 headers and payloads. The parser can generate a packet header vector (PHV) from packet 501. The packet header vector 506 can include many data fields including data from packet headers 507 and metadata 522. The metadata 522 can include data generated by the network appliance such as the hardware port 523 on which the packet 501 was received and the packet timestamps 524 indicating when the packet 501 was received by the network appliance, enqueued, dequeued, etc.

The source MAC address 508 and the destination MAC address 509 can be obtained from the packet's layer 2 header. The source IP address 511 can be obtained from the packet's layer 3 header. The source port 512 can be obtained from the packet's layer 4 header. The protocol 513 can be obtained from the packet's layer 3 header. The destination IP address 514 can be obtained from the packet's layer 3 header. The destination port 515 can be obtained from the packet's layer 4 header. The packet quality of service parameters 516 can be obtained from the packet's layer 3 header or another header based on implementation specific details. The virtual network identifier 517 may be obtained from the packet's layer 2 header. The multi-protocol label switching (MPLS) data 518, such as an MPLS label, may be obtained from the packet's layer 2 header. The other layer 4 data 519 can be obtained from the packet's layer 4 header. The L7 data fields 520 can be obtained from the packet's layer 7 header or layer 7 payload. The L7 data fields 520 can be obtained from the packet's layer 7 header or layer 7 payload. The other header information 521 is the other information contained in the packet's layer 2, layer 3, layer 4, and layer 7 headers.

The packet 5-tuple 510 is often used for generating keys for match tables, discussed below. The packet 5-tuple 510 can include the source IP address 511, the source port 512, the protocol 513, the destination IP address 514, and the destination port 515.

Those practiced in computer networking protocols realize that the headers carry much more information than that described here, realize that substantially all of the headers are standardized by documents detailing header contents and fields, and know how to obtain those documents. The parser can also be configured to output a packet or payload 505. Recalling that the parser 502 is a programmable element that is configured through the domain-specific language (e.g., P4) to extract information from a packet, the specific contents of the packet or payload 505 are those contents specified via the domain specific language. For example, the contents of the packet or payload 505 can be the layer 3 payload.

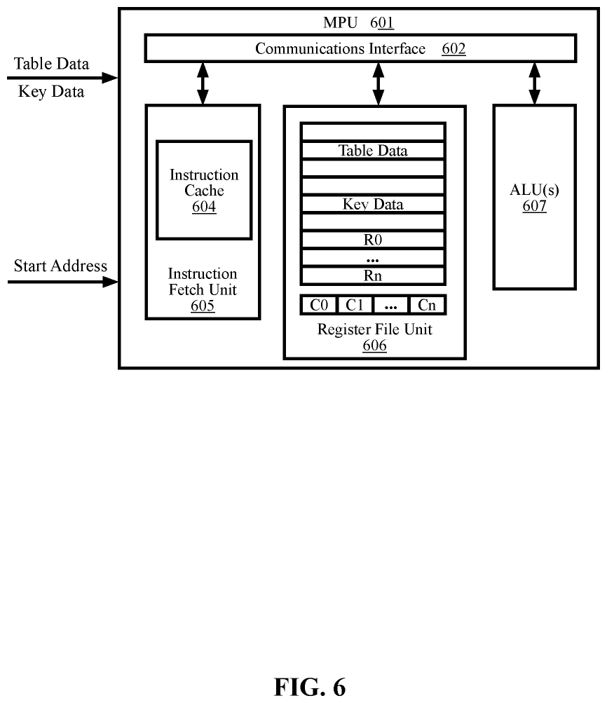

FIG. 6 illustrates a block diagram of a match processing unit (MPU) 601, also referred to as an action unit, that may be used within the exemplary system of FIG. 4 to implement some aspects. The MPU 601 can have multiple functional units, memories, and a register file. For example, the MPU 601 may have an instruction fetch unit 605, a register file unit 606, a communication interface 602, arithmetic logic units (ALUs) 607 and various other functional units.

In the illustrated example, the MPU 601 can have a write port or communication interface 602 allowing for memory read/write operations. For instance, the communication interface 602 may support packets written to or read from an external memory or an internal static random-access memory (SRAM). The communication interface 602 may employ any suitable protocol such as advanced extensible interface (AXI) protocol. AXI is a high-speed/high-end on-chip bus protocol and has channels associated with read, write, address, and write response, which are respectively separated, individually operated, and have transaction properties such as multiple-outstanding address or write data interleaving. The AXI interface 602 may include features that support unaligned data transfers using byte strobes, burst based transactions with only start address issued, separate address/control and data phases, issuing of multiple outstanding addresses with out of order responses, and easy addition of register stages to provide timing closure. For example, when the MPU executes a table write instruction, the MPU may track which bytes have been written to (a.k.a. dirty bytes) and which remain unchanged. When the table entry is flushed back to the memory, the dirty byte vector may be provided to AXI as a write strobe, allowing multiple writes to safely update a single table data structure as long as they do not write to the same byte. In some cases, dirty bytes in the table need not be contiguous and the MPU may only write back a table if at least one bit in the dirty vector is set. Though packet data is transferred according the AXI protocol in the packet data communication on-chip interconnect system according to the present exemplary embodiment in the present specification, it can also be applied to a packet data communication on-chip interconnect system operating by other protocols supporting a lock operation, such as advanced high-performance bus (AHB) protocol or advanced peripheral bus (APB) protocol in addition to the AXI protocol.

The MPU 601 can have an instruction fetch unit 605 configured to fetch instructions from a memory external to the MPU based on the input table result or at least a portion of the table result. The instruction fetch unit may support branches and/or linear code paths based on table results or a portion of a table result provided by a table engine. In some cases, the table result may comprise table data, key data and/or a start address of a set of instructions/program. The instruction fetch unit 605 can have an instruction cache 604 for storing one or more programs. In some cases, the one or more programs may be loaded into the instruction cache 604 upon receiving the start address of the program provided by the table engine. In some cases, a set of instructions or a program may be stored in a contiguous region of a memory unit, and the contiguous region can be identified by the address. In some cases, the one or more programs may be fetched and loaded from an external memory via the communication interface 602. This provides flexibility to allow for executing different programs associated with different types of data using the same processing unit. In an example, a management PHV can be injected into the pipeline, for example to perform administrative table direct memory access (DMA) operations or entry aging functions (i.e., adding timestamps), one of the management MPU programs may be loaded to the instruction cache to execute the management function. The instruction cache 604 can be implemented using various types of memories such as one or more SRAMs.

The one or more programs can be any programs such as P4 programs related to reading table data, building headers, DMA to/from memory, writing to/from memory, and various other actions. The one or more programs can be executed in any match-action unit.

The MPU 601 can have a register file unit 606 to stage data between the memory and the functional units of the MPU, or between the memory external to the MPU and the functional units of the MPU. The functional units may include, for example, ALUs, meters, counters, adders, shifters, edge detectors, zero detectors, condition code registers, status registers, and the like. In some cases, the register file unit 606 may comprise a plurality of general-purpose registers (e.g., R0, R1, . . . Rn) which may be initially loaded with metadata values then later used to store temporary variables within execution of a program until completion of the program. For example, the register file unit 606 may be used to store SRAM addresses, ternary content addressable memory (TCAM) search values, ALU operands, comparison sources, or action results. The register file unit of a stage may also provide data/program context to the register file of the subsequent stage, as well as making data/program context available to the next stage's execution data path (i.e., the source registers of the next stage's adder, shifter, and the like). In some embodiments, each register of the register file is 64 bits and may be initially loaded with special metadata values such as hash value from table lookup, packet size, PHV timestamp, programmable table constant and the like.

In some embodiments, the register file unit 606 can have a comparator flags unit (e.g., C0, C1, . . . Cn) configured to store comparator flags. The comparator flags can be set by calculation results generated by the ALU which in return can be compared with constant values in an encoded instruction to determine a conditional branch instruction. In some embodiments, the MPU can have one-bit comparator flags (e.g., 8 one-bit comparator flags). In practice, an MPU can have any number of comparator flag units each of which may have any suitable length.

The MPU 601 can have one or more functional units such as the ALU(s) 607. An ALU may support arithmetic and logical operations on the values stored in the register file unit 606. The results of the ALU operations (e.g., add, subtract, AND, OR, XOR, NOT, AND NOT, shift, and compare) may then be written back to the register file. The functional units of the MPU may, for example, update or modify fields anywhere in a PHV, write to memory (e.g., table flush), or perform operations that are not related to PHV update. For example, an ALU may be configured to perform calculations on descriptor rings, scatter gather lists (SGLs), and control data structures loaded into the general purpose registers from the host memory.

The MPU 601 can have other functional units such as meters, counters, action insert units, and the like. For example, an ALU may be configured to support P4 compliant meters. A meter is a type of action executable on a table match used to measure data flow rates. A meter may include a number of bands, typically two or three, each of which has a defined maximum data rate and optional burst size. Using a leaky bucket analogy, a meter band is a bucket filled by the packet data rate and drained at a constant allowed data rate. Overflow occurs if the integration of data rate exceeding quota is larger than the burst size. Overflowing one band triggers activity into the next band, which presumably allows a higher data rate. In some cases, a field of the packet may be marked as a result of overflowing the base band. This information might be used later to direct the packet to a different queue, where it may be more subject to delay or dropping in case of congestion. The counter may be implemented by the MPU instructions. The MPU can have one or more types of counters for different purposes. For example, the MPU can have performance counters to count MPU stalls. An action insert unit or set of instructions may be configured to push the register file result back to the PHV for header field modifications.

The MPU may be capable of locking a table. In some cases, a table being processed by an MPU may be locked or marked as “locked” in the table engine. For example, while an MPU has a table loaded into its register file, the table address may be reported back to the table engine, causing future reads to the same table address to stall until the MPU has released the table lock. For instance, the MPU may release the lock when an explicit table flush instruction is executed, the MPU program ends, or the MPU address is changed. In some cases, an MPU may lock more than one table address, for example, one for the previous table write-back and another address lock for the current MPU program.

In some embodiments, a single MPU may be configured to execute instructions of a program until completion of the program. In other embodiments, multiple MPUs may be configured to execute a program. A table result can be distributed to multiple MPUs. The table result may be distributed to multiple MPUs according to an MPU distribution mask configured for the tables. This provides advantages to prevent data stalls or mega packets per second (MPPS) decrease when a program is too long. For example, if a PHV requires four table reads in one stage, then each MPU program may be limited to only eight instructions in order to maintain a 100 MPPS if operating at a frequency of 800 MHz in which scenario multiple MPUs may be desirable.

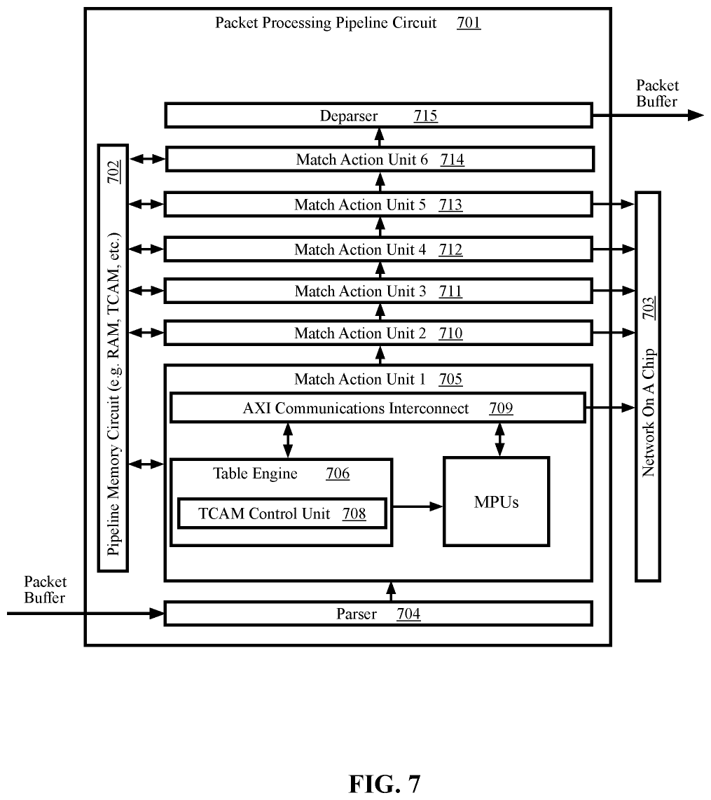

FIG. 7 illustrates a block diagram of a packet processing pipeline circuit 701 that may be included in the exemplary system of FIG. 4. A P4 pipeline can be programmed to provide various features, including, but not limited to, routing, bridging, tunneling, forwarding, network ACLs, L4 firewalls, flow based rate limiting, VLAN tag policies, membership, isolation, multicast and group control, label push/pop operations, L4 load balancing, L4 flow tables for analytics and flow specific processing, DDOS attack detection, mitigation, telemetry data gathering on any packet field or flow state and various others.

A programmer or compiler may decompose a packet processing program or flow processing data into a set of dependent or independent table lookup and action processing stages (i.e., match-action) that can be mapped onto the table engine and MPU stages. The match-action pipeline can have a plurality of stages. For example, a packet entering the pipeline may be first parsed by a parser (e.g., parser 704) according to the packet header stack specified by a P4 program. This parsed representation of the packet may be referred to as a packet header vector (PHV). The PHV may then be passed through processing stages (e.g., processing stages 705, 710, 711, 712, 713, 714) of the match-action pipeline. Each pipeline stage can be configured to match one or more PHV fields to tables and to update the PHV, table entries, or other data according to the actions specified by the P4 program. If the required number of stages exceeds the implemented number of stages, a packet can be recirculated for additional processing. The packet payload may travel in a separate queue or buffer until it is reassembled with its PHV in a deparser 715. The deparser 715 can rewrite the original packet according to the PHV fields which may have been modified in the pipeline. A packet processed by an ingress pipeline may be placed in a packet buffer for scheduling and possible replication. In some cases, once the packet is scheduled and leaves the packet buffer, it may be parsed again to create an egress PHV. The egress PHV may be passed through a P4 egress pipeline in a similar fashion as a packet passing through a P4 ingress pipeline, after which a final deparser operation may be executed before the packet is sent to its destination interface or recirculated for additional processing. The network appliance 430 of FIG. 4 has a P4 pipeline that can be implemented via a packet processing pipeline circuit 701.

A pipeline can have multiple parsers and can have multiple deparsers. The parser can be a P4 compliant programmable parser and the deparser can be a P4 compliant programmable deparser. The parser may be configured to extract packet header fields according to P4 header definitions and place them in a PHV. The parser may select from any fields within the packet and align the information from the selected fields to create the PHV. The deparser can be configured to rewrite the original packet according to an updated PHV. The pipeline MPUs of the match-action units 705, 710, 711, 712, 713, 714 can be the same as the MPU 601 of FIG. 6. Match-action units can have any number of MPUs. The match-action units of a match-action pipeline can all be identical.

A table engine 706 may be configured to support per-stage table match. For example, the table engine 706 may be configured to hash, lookup, and/or compare keys to table entries. The table engine 706 may be configured to control the address and size of the table, use PHV fields to generate a lookup key, and find Session Ids or MPU instruction pointers that define the P4 program associated with a table entry. A table result produced by the table engine can be distributed to the multiple MPUs.

The table engine 706 can be configured to control a table selection. In some cases, upon entering a stage, a PHV is examined to select which table(s) to enable for the arriving PHV. Table selection criteria may be determined based on the information contained in the PHV. In some cases, a match table may be selected based on packet type information related to a packet type associated with the PHV. For instance, the table selection criteria may be based on a debug flag, packet type or protocols (e.g., Internet Protocol version 4 (IPv4), Internet Protocol version 6 (IPv6), MPLSA, or the next table ID as determined by the preceding stage. In some cases, the incoming PHV may be analyzed by the table selection logic, which then generates a table selection key and compares the result using a TCAM to select the active tables. A table selection key may be used to drive table hash generation, table data comparison, and associated data into the MPUs.

The table engine 706 can have a ternary content-addressable memory (TCAM) control unit 708. The TCAM control unit may be configured to allocate memory to store multiple TCAM search tables. In an example, a PHV table selection key may be directed to a TCAM search stage before a SRAM lookup. The TCAM control unit may be configured to allocate TCAMs to individual pipeline stages to prevent TCAM resource conflicts, or to allocate TCAM into multiple search tables within a stage. The TCAM search index results may be forwarded to the table engine for SRAM lookups.

The table engine 706 may be implemented by hardware or circuitry. The table engine may be hardware defined. In some cases, the results of table lookups or table results are provided to the MPU in its register file.

A match-action pipeline can have multiple match-action units such as the six units illustrated in the example of FIG. 7. In practice, a match-action pipeline can have any number of match-action units. The match-action units can share a pipeline memory circuit 702 that can be static random-access memory (SRAM), TCAM, some other type of memory, or a combination of different types of memory. The packet processing pipeline circuit stores data in the pipeline memory circuit. For example, the packet processing pipeline circuit can store a table in the pipeline memory circuit that configures the packet processing pipeline circuit to process specific network flows. For example, a flow table or multiple flow tables may be stored in the pipeline memory circuit 702 and can store instructions and data that the packet processing pipeline circuit uses to process a packet. The pipeline memory circuit is more than half full when it is storing data used by the packet processing pipeline circuit and less than half the capacity of the pipeline memory circuit is free.

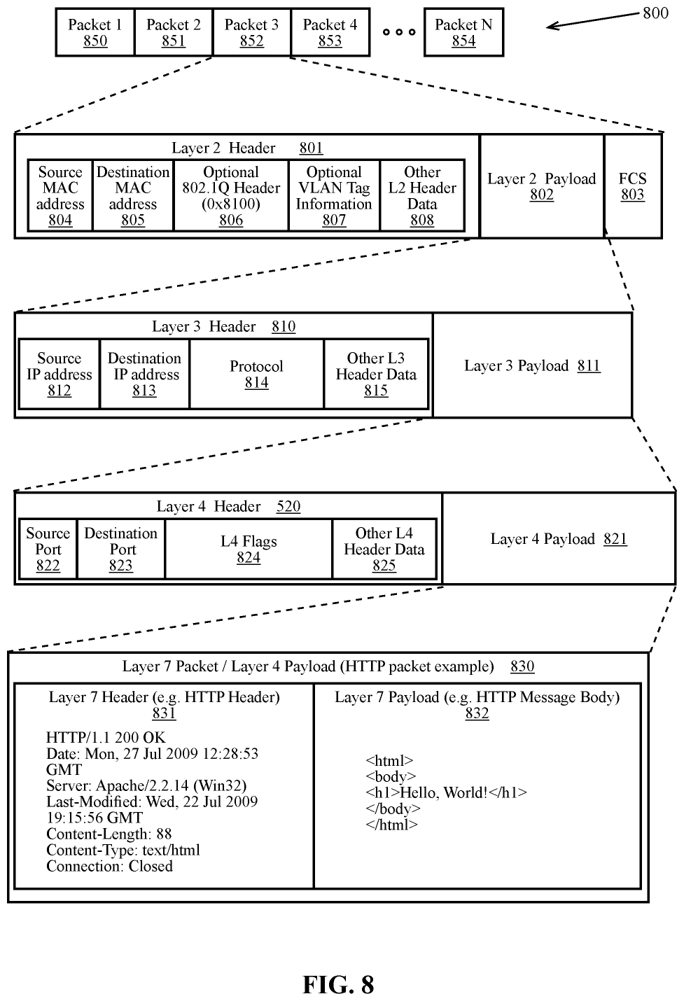

FIG. 8 illustrates packet headers and payloads of packets for a network flow 800 including layer 7 fields according to some aspects. A group of network packets passing from one specific endpoint to another specific endpoint is a network flow. A network flow 800 can have numerous network packets such as a first packet 850, a second packet 851, a third packet 852, a fourth packet 853, and a final packet 854 with many more packets between the fourth packet 853 and the final packet 854. The term “the packet” or “a packet” may refer to any of the network packets in a network flow.

Packets can be constructed and interpreted in accordance with the internet protocol suite. The Internet protocol suite is the conceptual model and set of communications protocols used in the Internet and similar computer networks. A packet can be transmitted and received as a raw bit stream over a physical medium at the physical layer, sometimes called layer 1. The packets can be received by a RX MAC 211 as a raw bit stream or transmitted by TX MAC 210 as a raw bit stream.

The link layer is often called layer 2. The protocols of the link layer operate within the scope of the local network connection to which a host is attached and includes all hosts accessible without traversing a router. The link layer is used to move packets between the interfaces of two different hosts on the same link. The packet has a layer 2 header 801, a layer 2 payload 802, and a layer 2 frame check sequence (FCS) 803. The layer 2 header can contain a source MAC address 804, a destination MAC address 805, an optional 802.1Q header 806, optional VLAN tag information 807, and other layer 2 header data 808. The input ports 211 and output ports 210 of a network appliance 201 can have MAC addresses. A network appliance 201 can have a MAC address that is applied to all or some of the ports. Alternatively, a network appliance may have one or more ports that each have their own MAC address. In general, each port can send and receive packets. As such, a port of a network appliance can be configured with a RX MAC 211 and a TX MAC 210. Ethernet, also known as Institute of Electrical and Electronics Engineers (IEEE) 802.3, is a layer 2 protocol. IEEE 802.11 (WiFi) is another widely used layer 2 protocol. The layer 2 payload 802 can include a layer 3 packet. The layer 2 FCS 803 can include a CRC (cyclic redundancy check) calculated from the layer 2 header and layer 2 payload. The layer 2 FCS can be used to verify that the packet has been received without errors.

IEEE 802.1Q is the networking standard that supports VLANs on IEEE 802.3 networks. The optional 802.1Q header 806 and VLAN tag information 807 are specified by the IEEE 802.1Q standard. The 802.1Q header is the two-octet value 0x8100 that indicates that VLAN tag information 807 is present. The VLAN tag information includes a 12-bit VLAN identifier. As such, a LAN can be configured to have 4094 VLANs (0x000 and 0xFFF are reserved values).

The internet layer, often called layer 3, is the network layer where layer 3 packets can be routed from a first node to a second node across multiple intermediate nodes. The nodes can be network appliances such as network appliance 201. Internet protocol (IP) is a commonly used layer 3 protocol. The layer 3 packet can have a layer 3 header 810 and a layer 3 payload 811. The layer 3 header 810 can have a source IP address 812, a destination IP address 813, a protocol indicator 814, and other layer 3 header data 815. As an example, a first node can send an IP packet to a second node via an intermediate node. The IP packet therefore has a source IP address indicating the first node and a destination IP address indicating the second node. The first node makes a routing decision that the IP packet should be sent to the intermediate node. The first node therefore sends the IP packet to the intermediate node in a first layer 2 packet. The first layer 2 packet has a source MAC address 804 indicating the first node, a destination MAC address 805 indicating the intermediate node, and has the IP packet as a payload. The intermediate node receives the first layer 2 packet. Based on the destination IP address, the intermediate node determines that the IP packet is to be sent to the second node. The intermediate node sends the IP packet to the second node in a second layer 2 packet having a source MAC address 804 indicating the intermediate node, a destination MAC address 805 indicating the second node, and the IP packet as a payload. The layer 3 payload 811 can include headers and payloads for higher layers in accordance with higher layer protocols such as transport layer protocols.

The transport layer, often called layer 4, can establish basic data channels that applications use for task-specific data exchange and can establish host-to-host connectivity. A layer 4 protocol can be indicated in the layer 3 header 810 using protocol indicator 814. Transmission control protocol (TCP), user datagram protocol (UDP), and internet control message protocol (ICMP) are common layer 4 protocols. TCP is often referred to as TCP/IP. TCP is connection oriented and can provide reliable, ordered, and error-checked delivery of a stream of bytes between applications running on hosts communicating via an IP network. When carrying TCP data, a layer 3 payload 811 includes a TCP header and a TCP payload. UDP can provide for computer applications to send messages, in this case referred to as datagrams, to other hosts on an IP network using a connectionless model. When carrying UDP data, a layer 3 payload 811 includes a UDP header and a UDP payload. ICMP is used by network devices, including routers, to send error messages and operational information indicating success or failure when communicating with another IP address. ICMP uses a connectionless model.

A layer 4 packet can have a layer 4 header 820 and a layer 4 payload 821. The layer 4 header 820 can include a source port 822, destination port 823, layer 4 flags 824, and other layer 4 header data 825. The source port and the destination port can be integer values used by host computers to deliver packets to application programs configured to listen to and send on those ports. The layer 4 flags 824 can indicate a status of or action for a network traffic flow. A layer 4 payload 821 can contain a layer 7 packet.

The application layer, often called layer 7, includes the protocols used by most applications for providing user services or exchanging application data over the network connections established by the lower level protocols. Examples of application layer protocols include RDMA over Converged Ethernet version 2, (RoCE v2), Hypertext Transfer Protocol (HTTP), File Transfer Protocol (FTP), Simple Mail Transfer Protocol (SMTP), and Dynamic Host Configuration (DHCP). Data coded according to application layer protocols can be encapsulated into transport layer protocol data units (such as TCP or UDP messages), which in turn use lower layer protocols to effect actual data transfer.

A layer 4 payload 821 may include a layer 7 packet 830. A layer 7 packet can have a layer 7 header 831 and a layer 7 payload 832. The illustrated layer 7 packet is an HTTP packet. The layer 7 header 831 is an HTTP header, and the layer 7 payload 832 is an HTTP message body. The HTTP message body is illustrated as a hypertext markup language (HTML) document. HTTP is specified in requests for comment (RFCs) published by the Internet Engineering Task Force (IETF). IETF RFC 7231 specifies HTTP version 1.1. IETF RFC 7540 specifies HTTP version 2. HTTP version 3 is not yet standardized, but a draft standard has been published by the IETF as “draft-ietf-quic-http-29”. HTML is a “living” standard that is currently maintained by Web Hypertext Application Technology Working Group (WHATWG). The HTTP header can be parsed by a P4 pipeline because it has a well-known format having well known header fields. Similarly, HTML documents can be parsed, at least in part, by a P4 pipeline to the extent that the HTML document has specific fields, particularly if those specific fields reliably occur at specific locations within the HTML document. Such is often the case when servers consistently respond by providing HTML documents.

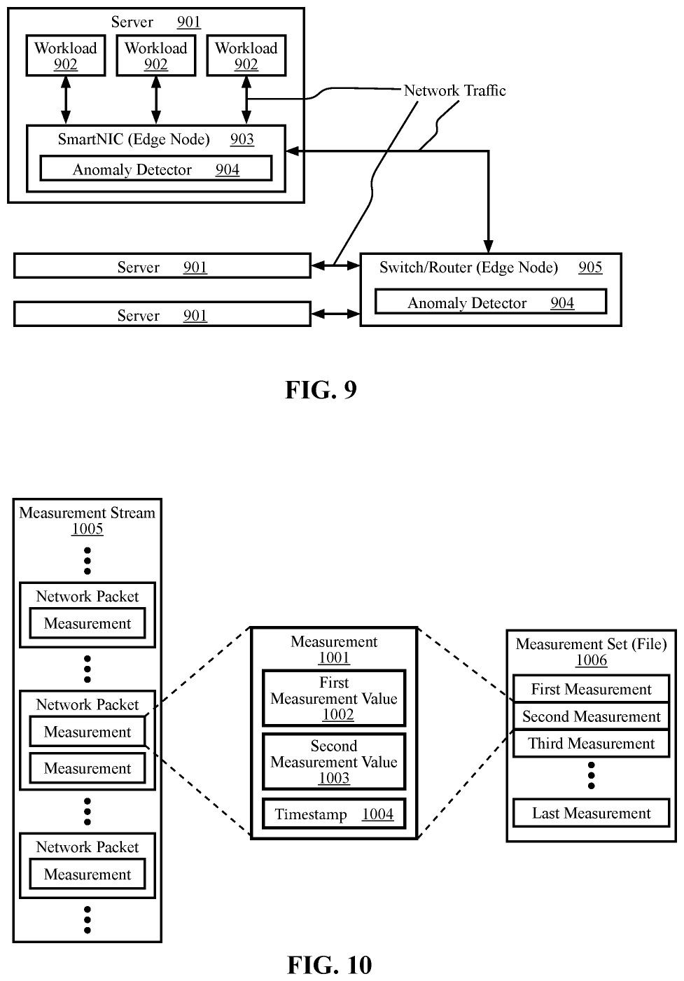

FIG. 9 is a high-level diagram illustrating edge nodes providing networking services to workloads 902 according to some aspects. A SmartNIC 903 is a network appliance that can be part of or installed in a server 901. The SmartNIC 903 may therefore be an edge node that includes an anomaly detector 904. The SmartNIC can provide network connectivity and network services to workloads 902 that are running on the server 901. The SmartNIC can implement network services that are provided to the workloads (e.g., TCP stacks, UDP stacks, NVMe-oF stacks, RDMA, etc.). Workloads can be virtual machines (VMs) hosted by the servers. For example, the SmartNIC can implement entire IP stacks (TCP/IP, UDP/IP, etc.) that are used by the workloads 902. The SmartNIC may also provide communications stacks for accessing remote storage (RDMA, NVMe-oF, etc.) that the workloads use to access remote non-volatile memory. The anomaly detector 904 may therefore detect anomalies in the network traffic of the workloads, network connectivity of the workloads, and the network services provided to the workloads. Switches and routers 905 are also network appliances that can include an anomaly detector 904. Switches and routers process network traffic between servers/workloads and other servers/workloads. As such, switches/routers may produce telemetry data related to their switching and routing functions.

FIG. 10 is a high-level diagram illustrating a measurement stream 1005 and a measurement set 1006 according to some aspects. A measurement stream 1005 can include a series of measurements that are included in a series of network packets. Each of the network packets can include one or more measurement. Those practiced in computer communications are familiar with data streams such as measurement streams 1005. A measurement set 1006 can be a number of measurements. The measurement set 1006 can be stored in a file, a group of files, a database, etc. A measurement 1001 can include a number of measurement values (e.g., a first measurement value 1002, a second measurement value 1003, etc.) and a timestamp 1004. The measurement values can be measurements of different network performance metrics (e.g., TCP bandwidth, UDP bandwidth, IO read/write bandwidth, etc.). The timestamp can indicate the time at which the measurements were obtained. Other data in a measurement 1001, measurement stream 1005, or measurement set 1006 can indicate which edge node produced the data. A measurement set 1006 may include measurements produced by numerous edge nodes.

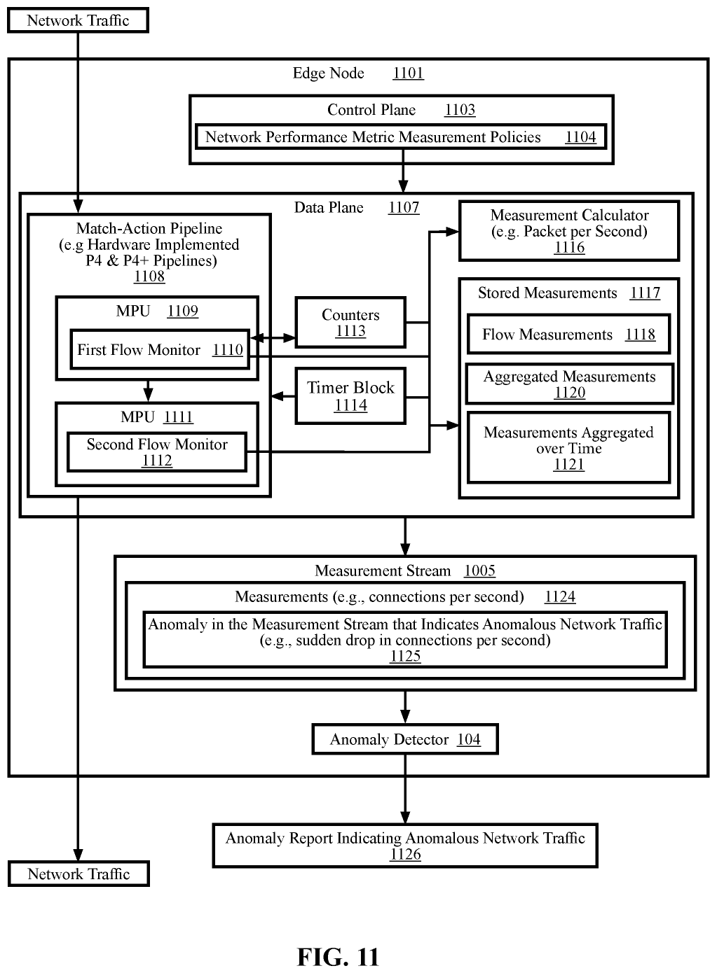

FIG. 11 is a high-level diagram illustrating an edge node 1101 producing a measurement stream 1005 that includes measurements 1124 that are values obtained by measuring a network performance metric according to some aspects. The edge node 1101 can have a control plane 1103 and a data plane 1107. The control plane 1103 can store network performance metric measurement policies and can configure the data plane 1107 to produce measurements in accordance with those policies. The aspects of FIG. 11 can be implemented by the network appliance 430 illustrated in FIG. 4 and the network appliances 903, 905 illustrated in FIG. 9. The edge node 1101 has a match-action pipeline 1108 that receives input packets of network traffic flows and produces output packets of the network traffic flows. The match-action pipeline 1108 can include hardware implemented P4 pipelines as discussed above. A first MPU 1109 of the match action pipeline 1108 can be configured to implement a first traffic flow monitor 1110. A second MPU 1111 of the match action pipeline 1108 can be configured to implement a second traffic flow monitor 1112. The data plane 1107 can include counters 1113 that can count aggregate numbers of packets, packets with certain contexts, aggregate numbers of bytes transferred, events (e.g., TCP retransmits), etc. The timer block 1114 can include timers (e.g., hardware clocks 424 of ASIC 401 shown in FIG. 4) and can produce a time value such as a timestamp or an elapsed time. A measurement calculator 1116 can receive lower level metrics (e.g., counts from the counters, times or elapsed time from the timers, etc.) and can calculate other metrics such as bandwidth and throughput. Note: a calculation can use a network performance metric measurement policy's specified sampling interval instead of an elapsed time measurement. The network appliance can have stored measurements 1117 such as flow measurements 1118, aggregated measurements 1120, and measurements aggregated over time 1121. Flow measurements 1118 relate to the packets of the network traffic flows processed by the network appliance. Measurements can have a context such as a count of packets having a certain 5-tuple. Data such as flow measurements can be aggregated into aggregated measurements. Aggregated measurements can relate to measurements that are gathered together. As such, aggregated measurements can be viewed as aggregations of measurements, metadata, etc. Aggregated measurements can have a context. Non-limiting examples of contexts include: source address; destination address; source/destination pairs; services, protocol, and 5-tuple. An address may be specified as an address range. For example, an IPv4 subnet can be specified as an address and a subnet mask (e.g., 192.168.0.0/255.255.0.0 for all hosts on the 192.168.x.x subnet). A service may be determined by the destination port (e.g., HTTP at TCP port 80, HTTPS at TCP at port 8080, NVMe/iWARP at TCP port 4420 and UDP port 4420). Note: iWARP is not an acronym, it relates to remote direct memory access (RDMA) as is used by RDMA over converged ethernet (RoCE). The service may also be determined by inspecting the layer 7 packet in a layer 4 payload, which is sometimes called deep packet inspection.

Aggregated measurements 1120 can include collections of data within a context such as packet count, packet loss, bandwidth, and outstanding TCP connection requests for a destination address. Measurements aggregated over time 1121 can include flow measurements 1118, aggregated measurements 1120, and other parameters that are aggregated over time by being stored periodically, added to a histogram bucket, in association with a timestamp, etc. measurements aggregated over time 1121 can be used for producing histograms for inclusion in external data expositions. The stored measurements 1117 are illustrated as stored in the data plane. Certain of the metrics can be stored elsewhere such as in the off ASIC memory 432 of the network appliance 430 shown in FIG. 4. The measurements aggregated over time 1121 can be a series of timestamped measurements of specific metrics.

The measurements (e.g., flow measurements 1118, aggregated measurements 1120, measurements aggregated over time 1121) can be sent to the anomaly detector 104 as a measurement stream 1005. The measurement stream 1005 can include measurements 1124 of metrics (e.g., connections per second). An anomaly 1125 in the measurement stream can indicate anomalous network traffic. For example, a sudden drop in connections per second may indicate that a network cable has been broken or unplugged, that upstream or down stream network appliances are failing to process traffic, or that the edge node itself is misconfigured or suffering some type of failure. The anomaly detector 104 may discover the anomaly 1125 and generate an anomaly report 1126 that indicates that there is anomalous network traffic.

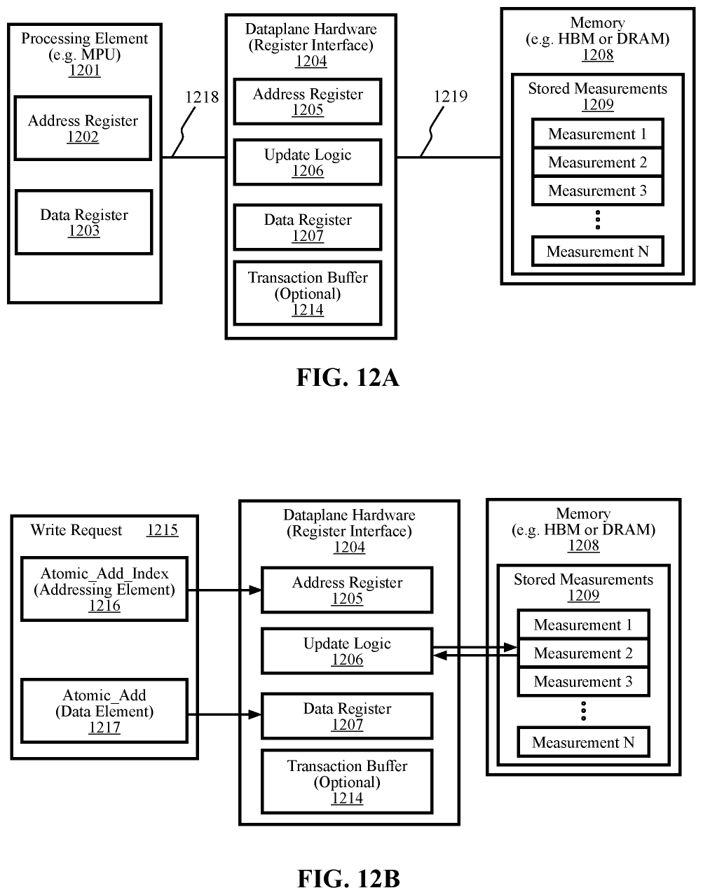

FIG. 12A and FIG. 12B are high-level diagrams illustrating the production and storage of measurement values for network performance metrics according to some aspects. FIG. 12A and FIG. 12B illustrates a data plane register interface 1204 configured to provide write operations that may be executed without halting an MPU 1201. The register interface 1204 can provide for updating counters and measurements that are stored in memory without halting or delaying an MPU. Halting an MPU 1201 while reading data from a memory 1208 or writing data to a memory 1208 can interfere with processing packets at line speed. A pipeline's MPUs can be configured to implement flow monitors, which may need to increment counters or store calculated values. For example, a packet 5-tuple may match a monitored flow for which at least one counter is to be incremented (e.g., a packet counter counting packets within the context of the 5-tuple). Updating the counter may incur wait states, particularly if the counter is not located within the pipeline's memory.

A processing element 1201, such as an MPU, can update stored measurements 1209 stored in memory 1208 via a register interface 1204. The processing element 1201 can include an address register 1202 and a data register 1203. The address register 1202 can indicate a location of a measurement record in the memory and the data register 1203 can indicate a value by which the measurement stored in the measurement record is to be incremented, decremented, etc. The register interface can include an address register 1205, update logic 1206, a data register 1207, and a transaction buffer 1214. The memory, which can be DRAM or high bandwidth memory (HBM), can store measurements in measurement records such as measurement record 1, measurement record 2, measurement record 3, and measurement record N.

The register interface 1204 can be configured to implement operations related to metrics management as is described below. The register interface includes an address register 1205, a data register 1207, and update logic 1206. The register interface can be integrated onto the same IC device as the processing element 1201 and the address register 1205 and data register 1207 are used to hold components of write requests. For example, with regard to the write requests, the address register 1205 can hold an index (e.g., atomic_add_index) that is used to identify a measurement record storing a measurement in the memory and the data register 1207 can hold a data element (e.g., data_element) that is used to update the identified measurement that is stored in the memory 1208. The address register 1205 and the data register 1405 can be 64-bit hardware registers that are implemented in hardware circuits such as flip-flop circuits as is known in the field. Although the address and data registers are described as 64-bit registers, the address and data registers could be of a different size, such as, for example, 32-bit registers. The address and data registers of the register interface can be embodied as a small amount of fast storage that is external to the processing element 1201 and that is distinct from the processing element address and data registers that may be incorporated into the processing element 1201, e.g., as part of an intellectual property (IP) block that is often provided by third-party CPU or MPU providers. Although not shown in FIGS. 12A and 12B, the register interface may include a first set of address and data registers for receiving write requests from the processing element and a second set of address and data registers for returning information related to write requests (e.g., a write response). For example, a write response may involve a simple “write done” or “write error” indicator. The register interface may include additional registers (e.g., a transaction buffer 1214) to buffer multiple write requests. The register interface may also have access to clock information such as a hardware clock or system clock of the network appliance. The clock information may be used to generate timestamps, which may be used for time-related metrics.

The address register 1205 and the data register 1207 of the register interface 1204 can be connected to the corresponding address and data registers, 1202 and 1203, within the processing element 1201 via a bus 1218 (e.g., the coherent interconnect 402 as described above with reference to FIG. 4). The coherent interconnect that interconnects the processing element 1201 and the register interface 1204 can include circuits that steer write requests from the processing element to the register interface based on an address in the write requests.

The update logic 1206 of the register interface 1204 can be implemented in hardware circuits that interact with the address register 1205 and the data register 1207 and with stored measurements 1209 that may be stored as an array in the memory 1208 to service write requests received from the processing element 1201. For example, the update logic 1206 can include hardware circuits configured to implement finite state machines (FSMs) that perform measurement update operations that include reading measurements from the memory, updating measurements to generate updated measurements, and then writing the updated measurements back to the memory. The update logic can be implemented as a pipeline machine that include a stage for decoding write requests, a stage for reading measurements from the array of measurements that are stored in the memory, a stage for updating measurements (e.g., executing add operations), and a stage for writing updated measurements back to the array of measurements that are stored in the memory. Operations of the register interface are described in more detail below with reference to FIG. 12B.

Turning now to the memory 1408, the memory can be general purpose memory such as random access memory (RAM). For example, the memory can be double-data rate synchronous dynamic RAM (DDR-SDRAM or simply DDR), although the RAM may be static RAM (SRAM), dynamic RAM (DRAM), synchronous DRAM (SDRAM), or a combination thereof. As illustrated in FIGS. 12A and 12B, the memory can store the measurements as an array of measurements 1209. In general, a measurement record stores a data element that corresponds to a measurement that is maintained in the memory. For example, data elements may include data that is used to maintain a measurement such as packet count, total bytes count, event count, histograms such as packet distribution, and timestamps such as packet arrival time and request latency.

FIG. 12B illustrates operations associated with a write request that occurs in a data plane and the memory of a network appliance. For example, the operations performed by the register interface 1204 in response to a write request from a processing element can include receiving a write request for a measurements update, where the write request includes an index (e.g., atomic_add_index) for use in generating the physical memory address of the measurement record in the array of stored measurements 1209, and then reading the measurements from the array according to the generated physical memory address. A write request can be received at the address register 1205 of the register interface and at the data register 1207 of the register interface. The data received at the address register can be a first binary value that includes a base address and an index (e.g., atomic_base_address+atomic_add_index), in which the index corresponds to a particular measurement record. The data received at the data register can be a second binary value that includes a data element (e.g., data_element) that is used to update the measurements. The index in the address register can be used by the register interface to read the corresponding measurement record in the array of measurement records 1209. For example, the register interface can use the index to generate a physical memory address of the measurement record in the memory. After the physical memory address of the measurement record in the memory is determined, the measurement is read from the array of measurement records, and an update operation is executed by the update logic. For example, the update logic may execute an add operation in which the value of the data element (e.g., data_element) in the data register is added to the value of the data element that was read from the measurement record. For example, the add operation involves adding a packet to an existing packet count, adding bytes to an existing total bytes count, adding an event to an event count, adding a value to a bucket of a histogram, updating a timestamp, or updating a request latency. Once an updated measurement is generated from the update operation, the updated measurements can be written back to the measurement record in the memory. Once the write to the memory is complete, the register interface may acknowledge to the processing element that the write was completed (e.g., write response). The write may be acknowledged to the processing element as soon as the write request arrives at the register interface. Alternatively, the write may be acknowledged to the processing element after the update operation is complete.

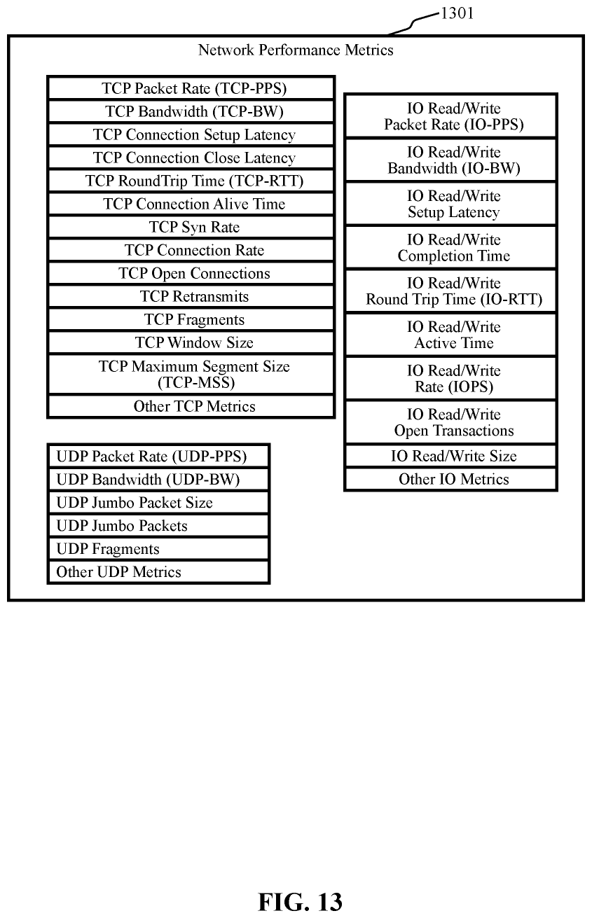

FIG. 13 is a high-level diagram illustrating network performance metrics 1301 that can be measured to produce measurement values according to some aspects. The illustrated network performance metrics 1301 is a non-limiting example because, in practice, many more metrics can be and often are measured. The metrics may be measured in the data plane of an edge node. The metrics include TCP metrics, UDP metrics, and storage metrics. The metrics 1301 can be stored and updated in memory as described above with respect to FIGS. 12A and 12B.

The TCP metrics include: TCP Packet Rate (TCP-PPS); TCP Bandwidth (TCP-BW); TCP Connection Setup Latency; TCP Connection Close Latency; TCP Round Trip Time (TCP-RTT); TCP Connection Alive Time; TCP Syn Rate; TCP Connection Rate; TCP Open Connections; TCP Retransmits; TCP Fragments; TCP Window Size; TCP Maximum Segment Size (TCP-MSS); and other TCP Metrics.

The UDP metrics include: UDP Packet Rate (UDP-PPS); UDP Bandwidth (UDP-BW); UDP Jumbo Packet Size; UDP Jumbo Packets; UDP Fragments; and other UDP Metrics.

The storage metrics, can be associated with NVMe/TCP, NVMEoF, and RoCE traffic and include: IO Read/Write Packet Rate (IO-PPS); IO Read/Write Bandwidth (IO-BW); IO Read/Write Setup Latency; IO Read/Write Completion Time; IO Read/Write Round Trip Time (IO-RTT); IO Read/Write Active Time; IO Read/Write Rate (IOPS); IO Read/Write Open Transactions; IO Read/Write Size; and other IO Metrics.

Those familiar with network traffic monitoring are familiar with the exemplary metrics shown in FIG. 13. Network appliances that are operating as edge nodes can be configured to generate the metrics of FIG. 13.

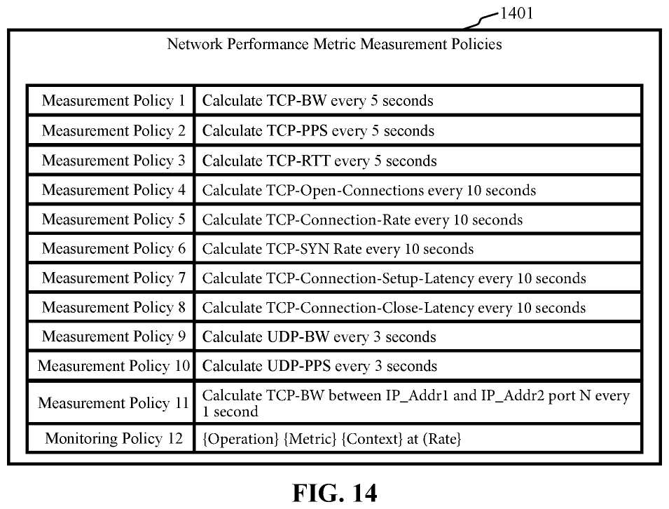

FIG. 14 is a high-level diagram illustrating network performance metric measurement policies 1401 according to some aspects. The network performance metric measurement policies 1401 shown in FIG. 14 is a non-limiting example of policies 1401 that may be implemented by a data plane. Network appliances that are operating as edge nodes can be configured to implement the measurement policies of FIG. 14. Measurement policy 1 is to calculate TCP-BW every 5 seconds. Measurement policy 2 is to calculate TCP-PPS every 5 seconds. Measurement policy 3 is to calculate TCP-RTT every 10 seconds. Measurement policy 4 is to calculate TCP-Open-Connections every 10 seconds. Measurement policy 5 is to calculate TCP-Connection-Rate every 10 seconds. Measurement policy 6 is to calculate TCP-SYN Rate every 10 seconds. Measurement policy 7 is to calculate TCP-Connection-Setup-Latency every 10 seconds. Measurement policy 8 is to calculate TCP-Connection-Close-Latency every 10 seconds. Measurement policy 9 is to calculate TCP-BW every 3 seconds. Measurement policy 10 is to calculate TCP-PPS every 3 seconds.

For brevity, the first ten measurement policies are shown without a context. Measurement policy 11 is to calculate TCP-BW between IP Addr1 and IP Addr2 port N every 1 second. Here, a context is given. The TCP bandwidth between two IP addresses is to be measured every second. Monitoring policy 12 is a non-limiting example of a general form of a measurement policy: {Operation} {Metric} {Context} at (Rate}. “Operation” can be to calculate, to read, or to perform some other operation. For example, bandwidth is calculated whereas other metrics such as packets per second may be available as a stored flow measurement that can be read directly from a memory location or counter. The metric that is calculated or read can be any of the metrics illustrated in FIG. 13 or other metrics familiar to those practiced in the arts of network traffic monitoring or device monitoring. “Context” can indicate the packets for which the metric is to be determined. “Rate” can indicate the time interval between calculating or reading the metric. The network performance metric measurement policies 1401 shown in FIG. 14 provide a non-limiting example of network performance metric measurement policies that may be implemented by a network appliance.

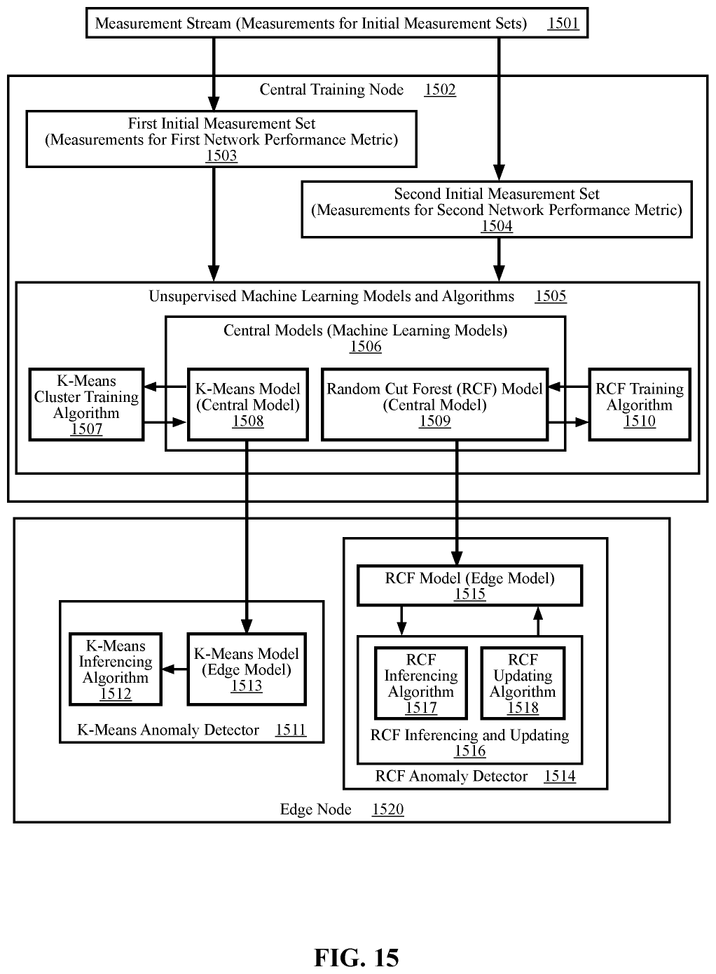

FIG. 15 is a high-level diagram illustrating a central training node 1502 and an edge node 1520 using K-means machine learning techniques and random cut forest (RCF) machine learning techniques according to some aspects. The central training node 1502 can receive a measurement stream 1501. The measurement stream 1501 can contain numerous measurements that the central training node stores in a first initial measurement set 1503 and a second initial measurement set 1504. The first initial measurement set 1503 can be an initial measurement set that contains measurements for a first network performance metric. The second initial measurement set 1504 can be an initial measurement set that contains measurements for a second network performance metric. The measurement stream 1501 may be one of many measurement streams that are received from data sources such as edge nodes. As such, numerous edge nodes may produce measurements for the first network performance metric that are stored in the first initial measurement set 1503. In addition, numerous edge nodes may produce measurements for the second network performance metric that are stored in the second initial measurement set 1504.

Unsupervised machine learning algorithms and models 1505 can include central models, and training algorithms such as a K-means cluster training algorithm 1507, and a RCF training algorithm 1510. The central models are machine learning models such as a K-means model 1508 and a RCF model 1509. The first initial measurement set 1503 can be used by the K-means cluster training algorithm 1507 to train the K-means model 1508. The second initial measurement set 1504 can be used by the RCF training algorithm 1510 to train the RCF model 1509. As is notoriously well known in the art of machine learning, a machine learning model can be considered trained when it meets certain criteria with respect to a training set. The specific criteria are model/algorithm dependent and can be set by a person. For example, currently available (via download, “import” directive, etc.) python libraries for K-means and RCF may take the criteria as input values such that the training algorithms in the libraries can exit when the criteria are met. Python is a computer programming language that is commonly used by machine learning practitioners. Python libraries are code (often open source and freely available) that a programmer can incorporate in a python program by using the “import” command.

Once trained, the central models 1506 can be sent to edge nodes where they can be installed as edge models that can be used by anomaly detectors in the edge nodes. An edge node 1520 may contain a K-means anomaly detector 1511 and a RCF anomaly detector 1514. The K-means anomaly detector 1511 can include a K-means inferencing algorithm 1512 and a K-means model 1513. The K-means model 1513 can be a machine learning model received from the central training node 1502 that has been installed in the K-means anomaly detector 1511. The RCF anomaly detector 1514 can include a RCF inferencing and updating algorithms 1516 and a RCF model 1515. An aspect of RCF algorithms is that an RCF model can continue being trained while it is also being used to detect anomalies in a measurement stream. As such, the RCF anomaly detector 1514 includes a RCF inferencing algorithm 1517 and a RCF updating algorithm 1518. The RCF updating algorithm 1518 can use a measurement stream to update the RCF model 1515 while the RCF inferencing algorithm 1517 detects anomalies in the measurement stream. The RCF model 1515 can be a machine learning model received from the central training node 1502 that has been installed in the RCF anomaly detector 1514. The example illustrated in FIG. 15 uses a first machine learning model (e.g., K-means cluster model), a first training algorithm (e.g., K-means cluster training algorithm), a first inferencing algorithm (e.g., K-means inferencing algorithm), a second machine learning model (e.g., RCF model), a second training algorithm (e.g., RCF training algorithm), and a second inferencing algorithm (e.g., RCF inferencing algorithm).

An initial measurement set can include measurements for a single metric. Each measurement can be a scalar value. A sequence of scalar values can be used to train a machine learning model and that model, after being trained, may be used for detecting anomalous scalar values in a stream of measurements of that single metric. Instead of simply using a single scalar value, consecutive measurements may be combined into vectors. For example, N consecutive data points may be combined into an N-dimensional vector. In machine learning, this technique is often called “shingling” wherein the N-dimensional vectors are called shingles. The machine learning models may thereby be trained on shingles and the anomaly detector may detect anomalous shingles. An anomalous shingle may be an N-dimensional vector that contains one or more anomalous measurement values.

The measurements in an initial measurement set may be vectors. As discussed above, the vectors may be N-dimensional vectors that are shingles of measurements of a single metric. The vectors may instead be N-dimensional vectors that include N measurements of N different metrics. Alternatively, the vectors may be N-dimensional vectors that include shingles where a first shingle includes measurements of a first metric and a second shingle includes measurements of a second metric. Regardless of the shingling and the scalar values included in the vectors, machine learning models may thereby be trained on the vectors and the anomaly detector may detect anomalous vectors. An anomalous vector may be an N-dimensional vector that contains one or more anomalous measurement values.

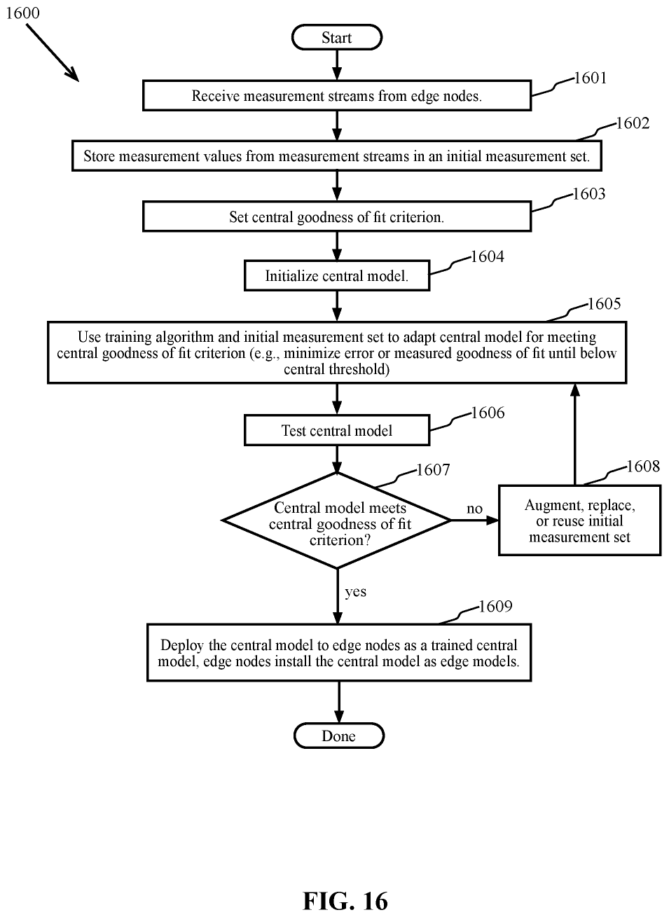

FIG. 16 is a high-level flow diagram illustrating a central model deployment process 1600 that a central training node can implement for deploying a trained central model to edge nodes according to some aspects. After starting, at block 1601 the process can receive measurement streams from edge nodes. At block 1602, the process can store measurement values from measurement streams in an initial measurement set. At block 1603, the process may set a central goodness of fit criterion that may be used by the training algorithm. The value used for the central goodness of fit criterion can be provided by a person. Those familiar with RCF algorithms are also familiar with the goodness of fit measurements that can be produced by RCF training algorithms and RCF inferencing algorithms. The goodness of fit measurement can indicate how well an RCF model fits an input data stream. At the central training node, the model may be considered trained when the goodness of fit measurement meets the central goodness of fit criterion. In some cases, smaller goodness of fit measurements indicate a better goodness of fit. In other cases, larger goodness of fit measurements indicate a better goodness of fit. If smaller goodness of fit measurements indicate a better goodness of fit, then a goodness of fit criterion may be met when the goodness of fit measurement is less than goodness of fit criterion. If larger goodness of fit measurements indicate a better goodness of fit, then a goodness of fit criterion may be met when the goodness of fit measurement is greater than goodness of fit criterion. At block 1604, the process can initialize the central model. At block 1605, the process can use a training algorithm and initial measurement set to adapt the central model for meeting the central goodness of fit criterion (e.g., minimize error or measured goodness of fit until below central threshold). At block 1606, the process can test the central model by, for example, producing a goodness of fit measurement. Note that RCF algorithms may produce the goodness of fit measurement as an aspect of the processing performed at block 1605. At decision block 1607, the process can determine whether the central model meets the central goodness of fit criterion. For example, a RCF central model meets the central goodness of fit criterion when the measured goodness of fit indicates that the central goodness of fit criterion is met. (e.g., measured goodness of fit<central goodness of fit criterion). If the central model does not meet the central goodness of fit criterion, the process can move to block 1608. If the central model meets the central goodness of fit criterion, the process can move to block 1609. At block 1608, the process can augment, replace, reuse, or in some way alter the initial measurement set. The initial measurement set can be augmented by adding additional measurements to the initial measurement set. The initial measurement set can be replaced by new measurements received from the edge nodes. The initial measurement set can be reused, in which case the same training data is used to train the model an additional time. The process loops back to block 1605 after block 1608. At block 1609, the process can deploy the central model to edge nodes as a trained central model, the edge nodes can install the central model as edge models. The process is done after block 1609.

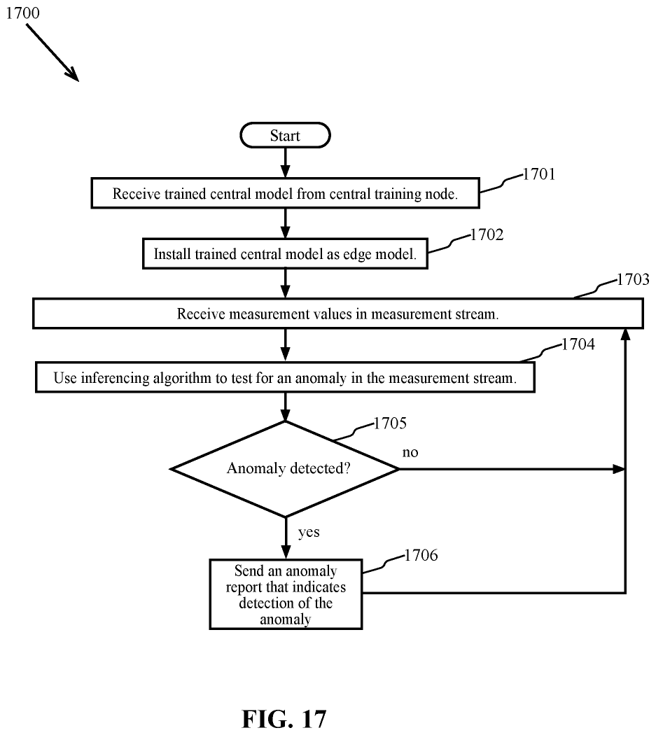

FIG. 17 is a high-level flow diagram illustrating an anomaly detection process 1700 that can be implemented by an edge node that has an anomaly detector using an edge model to detect anomalies according to some aspects. After starting, at block 1701 the process can receive a trained central model from the central training node. At block 1702 the process can install the trained central model as an edge model. At block 1703 the process can receive measurement values in a measurement stream. At block 1704 the process can use an inferencing algorithm to test for an anomaly in the measurement stream. The inferencing algorithm can use the edge model to determine if a measurement received at block 1703 is anomalous. At decision block 1705 the process can determine if the test at block 1704 indicated that an anomaly is detected. If an anomaly is not detected, the process can loop back to block 1703. If an anomaly is detected, the process can proceed to block 1706. At block 1706 the process can send an anomaly report that indicates detection of the anomaly. After block 1706, the process can loop back to block 1703.

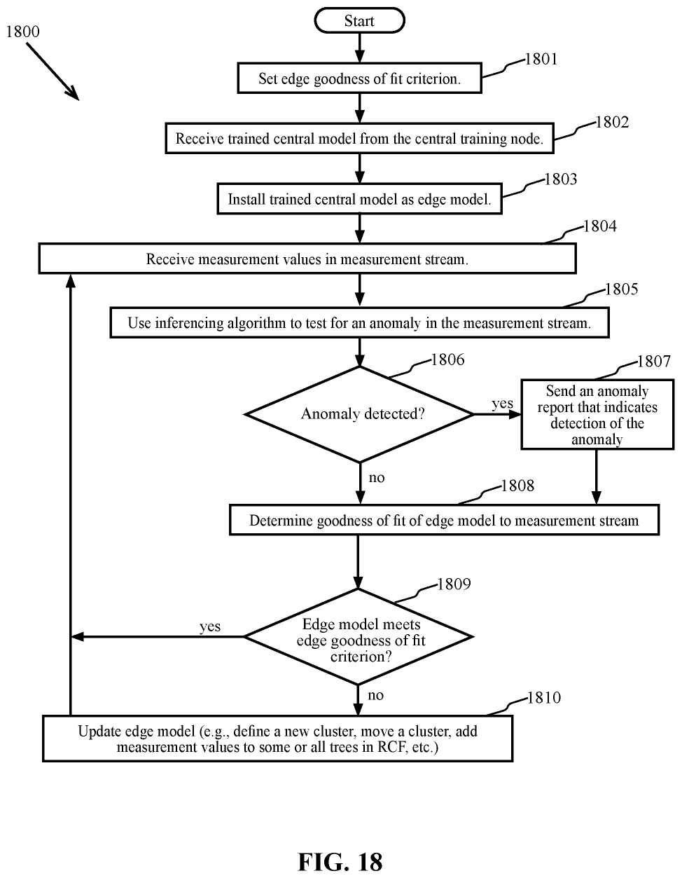

FIG. 18 is a high-level flow diagram illustrating an anomaly detection process 1800 that can be implemented by an edge node that has an anomaly detector using an edge model to detect anomalies and using a measurement stream to update the edge model according to some aspects. As discussed above, RCF algorithms may update the edge models that are used by the edge nodes. After starting, at block 1801 the process can set an edge goodness of fit criterion. The edge goodness of fit criterion may be set by a person, provided in a configuration file, etc. Those familiar with RCF algorithms are also familiar with the goodness of fit measurements that can be produced by RCF training algorithms and RCF inferencing algorithms. The goodness of fit measurement can indicate how well an RCF model fits an input data stream. At the central training node, the model is considered trained when the goodness of fit measurement meets the central goodness of fit criterion. At block 1802 the process can receive a trained central model from the central training node. The trained central model can be a RCF model. At block 1803 the process can install the trained central model as an edge model. At block 1804 the process can receive measurement values in a measurement stream. At block 1805 the process can use an inferencing algorithm to test for an anomaly in the measurement stream. The inferencing algorithm can use the edge model to determine if a measurement received at block 1804 is anomalous. At decision block 1806 the process can determine if an anomaly was detected at block 1805. If an anomaly was not detected, the process proceeds to block 1808. If an anomaly was detected the process goes to block 1807. At block 1807 the process can send an anomaly report that indicates the detection of the anomaly. The process continues to block 1808 after block 1807. At block 1808 the process can determine the goodness of fit of the edge model to the measurement stream. The RCF inferencing algorithm may produce a measured goodness of fit during inferencing. The measured goodness of fit indicates how well the edge model fits the measurement stream. At block 1809 the process can determine whether the edge model meets the edge goodness of fit criterion (e.g., measured goodness of fit<edge goodness of fit criterion). The process can loop back to block 1804 if the edge model meets the edge goodness of fit criterion. The process can go to block 1810 if the edge model does not meet the edge goodness of fit criterion. At block 1810 the process can update the edge model (e.g., define a new cluster, move a cluster, add measurement values to some or all trees in RCF, etc.). The process can loop back to block 1804 after block 1810.

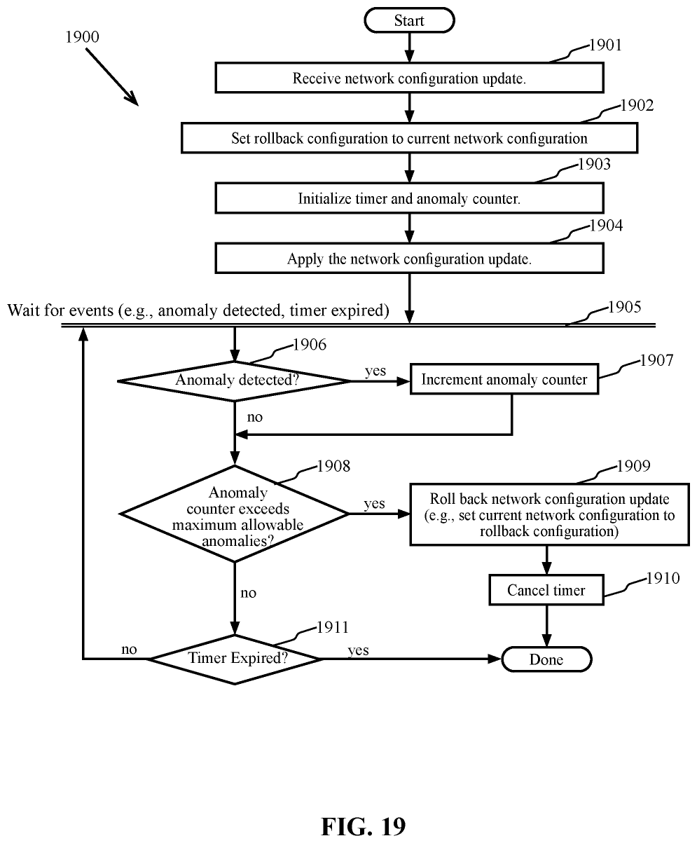

FIG. 19 is a high-level flow diagram illustrating an automatic rollback process 1900 that rolls back a configuration update based on the number of detected anomalies according to some aspects. After starting, at block 1901 the process can receive a network configuration update. A network configuration update can include new routing rules, amended routing rules, new firewall rules, amended firewall rules, new load balancing rules, amended load balancing rules, etc. At block 1902 the process can set the rollback configuration to the current network configuration. This step saves the current configuration such that it may be used again later. At block 1903 the process can initialize a timer and an anomaly counter. The timer can be set to an amount of time that is sufficient to determine if an upgrade is successful. For example, a network administrator may determine that one minute is sufficient and provide that value as an input to the process. At block 1904 the process can apply the network configuration update. At delay point 1905 the process can wait for events such as an anomaly detected event, a timer expired event, etc. The process goes to decision block 1906 when an event is detected. At decision block 1906 the process determined if an anomaly has been detected. If an anomaly has not been detected, the process goes to decision block 1908. If an anomaly has been detected, the process goes to block 1907. At block 1907 the process can increment the anomaly counter. A single anomaly may not be an indicator of a problem with the network configuration because anomalies occur constantly during normal and proper operation of the network. As such, the anomalies can be counted. The process goes to decision block 1908 after block 1907. At decision block 1908 the process can determine whether the anomaly counter exceeds a maximum allowable anomalies value. The maximum allowable anomalies can be a parameter that is set by a network administrator, a network equipment manufacturer, etc. The process goes to block 1909 if the anomaly counter exceeds the maximum allowable anomalies value. The process goes to block 1911 if the anomaly counter does not exceed the maximum allowable anomalies value. At block 1909 the process can roll back the network configuration update (e.g., set current network configuration to rollback configuration). At block 1909 the process can automatically roll back the network configuration update because, based on the number of anomalies, the new network configuration appears flawed. As such, the previous network configuration of the edge node can be restored. At block 1910 the process can cancel the timer before the process is done. At block 1911 the process can determine if the timer has expired. The process can loop back to delay point 1905 if the timer has not expired. The process is done if the timer has expired. Timer expiration indicates that the new network configuration appears good.

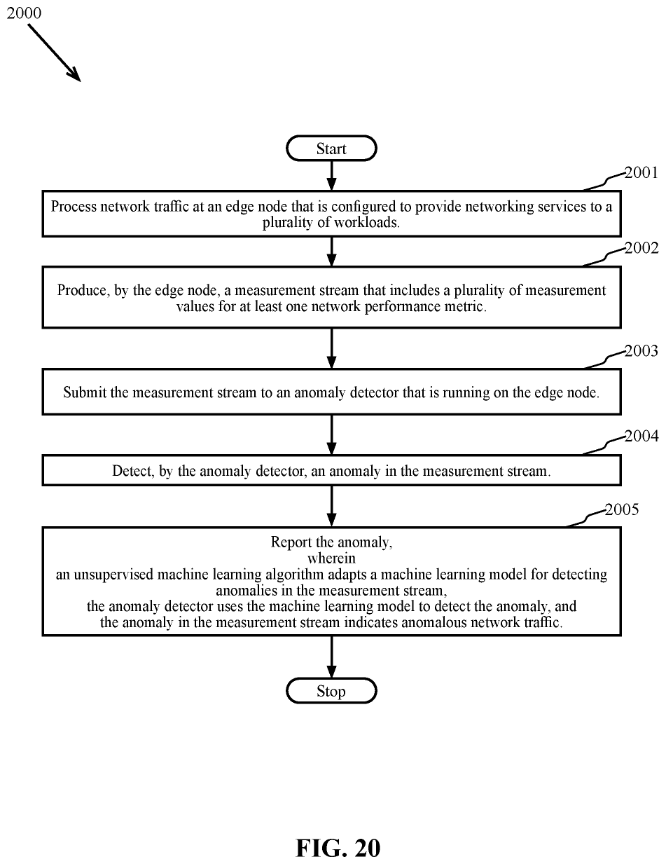

FIG. 20 is a high-level flow diagram illustrating a method for using unsupervised learning to detect network traffic processing anomalies at edge nodes 2000 according to some aspects. After the start, at block 2001 the method can process network traffic at an edge node that is configured to provide networking services to a plurality of workloads. At block 2002 the method can produce, by the edge node, a measurement stream that includes a plurality of measurement values for at least one network performance metric. At block 2003 the method can submit the measurement stream to an anomaly detector that is running on the edge node. At block 2004 the method can detect, by the anomaly detector, an anomaly in the measurement stream. At block 2005 the method can report the anomaly, wherein an unsupervised machine learning algorithm adapts a machine learning model for detecting anomalies in the measurement stream, the anomaly detector uses the machine learning model to detect the anomaly, and the anomaly in the measurement stream indicates anomalous network traffic.

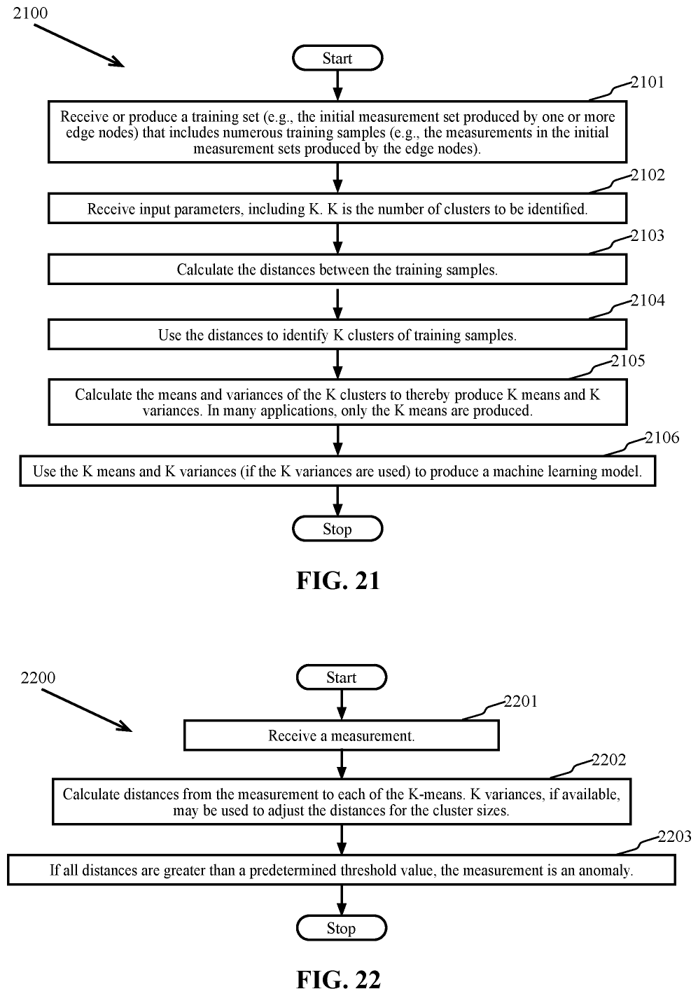

FIG. 21 is a high-level flow diagram illustrating a process for a K-means cluster learning algorithm to adapt a machine learning model for detecting an anomaly according to some aspects. The K-means cluster learning algorithm is one of the well-known clustering algorithms that are used as unsupervised learning algorithms. The other clustering algorithms may equivalently be used as unsupervised machine learning algorithms. After the start, at block 2101 the process can receive or produce a training set that includes numerous training samples. The training set can be the initial measurement set produced by one or more edge nodes. The training samples in the training set can be the measurements in the initial measurement sets produced by the edge nodes. At block 2102, the process can receive input parameters, including K. K is the number of clusters to be identified. At block 2103, the process can calculate the distances between the training samples. At block 2104, the process can use the distances to identify K clusters of training samples. At block 2105, the process can calculate the means and variances of the K clusters to thereby produce K means and K variances. In many applications, only the K means are produced. At block 2106, the process can use the K means and K variances (if the K variances are used) to produce a machine learning model. The machine learning model may be a list of K values, each of the K values being one of the cluster means. The machine learning model may be a list of K pairs of values, each of the K pairs values being the mean and the variance of one of the clusters.

FIG. 22 is a high-level flow diagram illustrating a process for an inferencing algorithm that uses a machine learning model produced via a K-means cluster learning algorithm to detect an anomaly according to some aspects. After the start, at block 2201 the process can receive a measurement. At block 2202, the process can calculate distances from the measurement to each of the K-means. K variances, if available, may be used to adjust the distances for the cluster sizes. For example, a Euclidean distance is the distance between two points such as a cluster mean and a measurement. The cluster variances may be used to scale the distances along the axes before calculating the Euclidean distance to thereby adjust the distances for large and small clusters. At block 2203, the process can determine if the measurement is an outlier. If all distances are greater than a predetermined threshold value, the measurement is an anomaly.

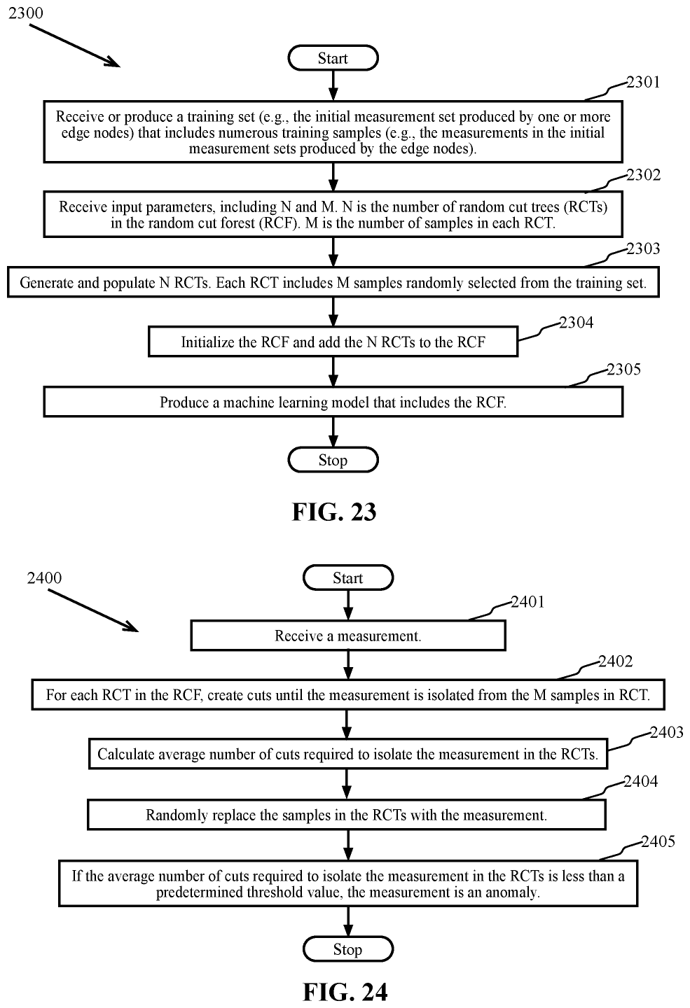

FIG. 23 is a high-level flow diagram illustrating a process for a random cut forest (RCF) learning algorithm to adapt a machine learning model for detecting an anomaly according to some aspects. The random cat forest learning algorithm is one of the well-known RCF algorithms that are used as unsupervised learning algorithms. The other RCF algorithms such as robust RCF (RRCF), weighted RCF (WRCF) may equivalently be used as unsupervised machine learning algorithms. After the start, at block 2301 the process can receive or produce a training set (e.g., the initial measurement set produced by one or more edge nodes) that includes numerous training samples (e.g., the measurements in the initial measurement sets produced by the edge nodes). At block 2302, the process can receive input parameters, including N and M. N is the number of random cut trees (RCTs) in the random cut forest (RCF). M is the number of samples in each random cut tree (RCT). At block 2303, the process can generate and populate N RCTs. Each RCT includes M samples randomly selected from the training set. Each of the RCTs can include M of the sample that are in the measurement set. The M samples for each RCT can be chosen randomly. Some samples may appear in multiple RCTs. Some samples may not be in any of the RCTs. At block 2304, the process can initialize the RCF and add the N RCTs to the RCF. In many implementations, the data structure for the RCF is generated and then populated by randomly selecting samples from the training set. The RCF data structure can be a N element list with each RCF element being a RCT data structure. The RCT data structure can be an M element list with each element storing a randomly selected training sample from the training set. At block 2305, the process can produce a machine learning model that includes the RCF. The machine learning model may be the RCF data structure.

FIG. 24 is a high-level flow diagram illustrating a process for an inferencing algorithm that uses a machine learning model produced via a RCF learning algorithm to detect an anomaly according to some aspects. After the start, at block 2301 the process can receive a measurement. At block 2402, the process can determine the number of cuts required to isolate the measurement in each RCT. For each RCT in the RCF, create cuts until the measurement is isolated from the M samples in RCT. At block 2403, the process can calculate the average number of cuts required to isolate the measurement in the RCTs. At block 2404, the process can randomly replace the samples in the RCTs with the measurement. Step 2404 is an aspect that is used by RCF algorithms that adapt to an input stream over time. Many implementations skip this step and do not adapt over time. For example, for each RCT there can be a 1% chance that one of the samples is replaced by the measurement. The sample to be replaced may also be randomly selected. Those practiced in programming are familiar with using random number generators to randomly select a sample or to perform an operation 1% (or any other percent) of the time. At block 2405, the process can determine if the measurement is an anomaly. If the average number of cuts required to isolate the measurement in the RCTs is less than a predetermined threshold value, the measurement is an anomaly.

Aspects described above can be ultimately implemented in a network appliance that includes physical circuits that implement digital data processing, storage, and communications. The network appliance can include processing circuits, ROM, RAM, TCAM, and at least one interface (interface(s)). The CPU cores described above are implemented in processing circuits and memory that is integrated into the same integrated circuit (IC) device as ASIC circuits and memory that are used to implement the programmable packet processing pipeline. For example, the CPU cores and ASIC circuits are fabricated on the same semiconductor substrate to form a System-on-Chip (SoC). The network appliance may be embodied as a single IC device (e.g., fabricated on a single substrate) or the network appliance may be embodied as a system that includes multiple IC devices connected by, for example, a printed circuit board (PCB). The interfaces may include network interfaces (e.g., Ethernet interfaces and/or InfiniBand interfaces) and/or PCIe interfaces. The interfaces may also include other management and control interfaces such as I2C, general purpose IOs, USB, UART, SPI, and eMMC.

As used herein the terms “packet” and “frame” may be used interchangeably to refer to a protocol data unit (PDU) that includes a header portion and a payload portion and that is communicated via a network protocol or protocols. A PDU may be referred to as a “frame” in the context of Layer 2 (the data link layer) and as a “packet” in the context of Layer 3 (the network layer). For reference, according to the P4 specification: a network packet is a formatted unit of data carried by a packet-switched network; a packet header is formatted data at the beginning of a packet in which a given packet may contain a sequence of packet headers representing different network protocols; a packet payload is packet data that follows the packet headers; a packet-processing system is a data-processing system designed for processing network packets, which, in general, implement control plane and data plane algorithms; and a target is a packet-processing system capable of executing a P4 program.

Although the operations of the method(s) herein are shown and described in a particular order, the order of the operations of each method may be altered so that certain operations may be performed in an inverse order or so that certain operations may be performed, at least in part, concurrently with other operations. Instructions or sub-operations of distinct operations may be implemented in an intermittent and/or alternating manner.

It should also be noted that at least some of the operations for the methods described herein may be implemented using software instructions stored on a computer usable storage medium for execution by a computer. As an example, an embodiment of a computer program product includes a computer usable storage medium to store a computer readable program.

The computer-usable or computer-readable storage medium can be an electronic, magnetic, optical, electromagnetic, infrared, or semiconductor system (or apparatus or device). Examples of non-transitory computer-usable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Although specific embodiments have been described and illustrated, the claims are not to be limited to the specific forms or arrangements of parts so described and illustrated. The scope of the claimed embodiments is to be defined by the claims appended hereto and their equivalents.

What is claimed is:

1. A system comprising:
a memory;
a CPU core operatively coupled to the memory; and
an edge node that includes the memory and the CPU core,
wherein
the edge node processes network traffic and provides networking services to a plurality of workloads,
the edge node produces a measurement stream that includes a plurality of measurement values for at least one network performance metric,
the measurement stream is submitted to an anomaly detector that is running on the edge node,
the anomaly detector detects an anomaly in the measurement stream,
the anomaly detector reports the anomaly,
the anomaly detector uses a machine learning model to detect the anomaly,
the machine learning model is adapted for detecting anomalies in the measurement stream by an unsupervised machine learning algorithm, and
the anomaly in the measurement stream indicates anomalous network traffic.

2. The system of claim 1, wherein:
the edge node includes a packet processing pipeline circuit that includes a plurality of match action units arranged as a match action pipeline; and
the edge node uses at least one of the match action units to produce the measurement stream.

3. The system of claim 1, wherein:
a central training node receives an initial measurement set that includes an initial plurality of measurement values for the at least one network performance metric;
the central training node uses the unsupervised machine learning algorithm adapts a central model to detect the anomaly;
the central model is installed in the edge node as an edge model; and
the machine learning model used by the anomaly detector is the edge model.

4. The system of claim 1, wherein:
the edge node receives a trained central model from a central training node;
the edge node installs the trained central model as an edge model in the anomaly detector; and
the edge model is the machine learning model.

5. The system of claim 4, wherein the edge node uses the unsupervised machine learning algorithm to further adapt the edge model for detecting anomalies in the measurement stream.

6. The system of claim 5, wherein:
the trained central model meets a central goodness of fit criterion;
the edge node has an edge goodness of fit criterion for the edge model; and
the edge node adapts the edge model for detecting anomalies in the measurement stream until the edge model meets the edge goodness of fit criterion.

7. The system of claim 4, wherein:
the edge node produces a first edge model training measurement stream; and
the edge node uses the unsupervised machine learning algorithm and the first edge model training measurement stream to further adapt the edge model for detecting anomalies in the measurement stream.

8. The system of claim 7, wherein the unsupervised machine learning algorithm is a K-means cluster learning algorithm.

9. The system of claim 8, wherein:
a second unsupervised machine learning algorithm adapts a second machine learning model for detecting anomalies in the measurement stream;
the anomaly detector uses the second machine learning model to detect a second anomaly; and
the second machine learning model is a random cut forest learning algorithm.

10. The system of claim 1, wherein the unsupervised machine learning algorithm is a clustering algorithm.

11. The system of claim 1, wherein the unsupervised machine learning algorithm is a K-means cluster learning algorithm.

12. The system of claim 1, wherein the unsupervised machine learning algorithm is a random cut forest learning algorithm.

13. The system of claim 1, wherein:
a central training node adapts a central model for detecting the anomaly;
a plurality of edge nodes install the central model as a plurality of edge models; and
at least two of the edge nodes use the edge models to detect the anomalous network traffic.

14. The system of claim 1, wherein:
a network configuration update is applied to the edge node before the anomaly is detected; and
the edge node automatically rolls back the network configuration update after the anomaly is detected.

15. The system of claim 1, wherein the measurement stream includes values for a plurality of network performance metrics.

16. A method comprising:
processing network traffic at a plurality of edge nodes that are configured to provide networking services to a plurality of workloads;
storing, by a central training node, an initial measurement set that includes a plurality of measurement values for at least one network performance metric that is related to processing of network traffic;
using an unsupervised machine learning algorithm to adapt a central model to detect an anomaly in the initial measurement set; and
deploying the central model to the edge nodes,
wherein
the edge nodes are running a plurality of anomaly detectors,
the central model is installed in the anomaly detectors as a plurality of edge models, and
the edge nodes use the anomaly detectors to detect anomalous network traffic processing.

17. The method of claim 16, wherein at least one of the edge nodes produces the initial measurement set.

18. The method of claim 16, wherein:
one of the edge nodes includes a pipeline circuit that includes a match action pipeline;
the one of the edge nodes uses the pipeline circuit to produce a measurement stream; and
the one of the edge nodes uses the measurement stream and one of the anomaly detectors to detect the anomalous network traffic processing.

19. A system comprising:
a network traffic processing means for providing networking services to a plurality of workloads;
a measurement means for producing a measurement stream for at least one network performance metric;
an anomaly detection means for detecting an anomaly in the measurement stream; and
a reporting means for reporting the anomaly,
wherein
an unsupervised machine learning algorithm adapts a machine learning model for detecting anomalies in the measurement stream,
the anomaly detection means uses the machine learning model to detect the anomaly, and
the anomaly in the measurement stream indicates anomalous network traffic.

20. The system of claim 19, further comprising:
a network configuration means for updating a network configuration from a first network configuration to a second network configuration; and
a rollback triggering means for triggering a configuration rollback means to roll back the network configuration from the second network configuration to the first network configuration.
